(19) United States
(12) Patent Application Publication
(10) Pub. No.: US 2001/0024278 A1
(43) Pub. Date: Sep. 27, 2001

(54) Position detecting method and apparatus, exposure method, exposure apparatus and manufacturing method thereof, computer-readable recording medium, and device manufacturing method

(75) Inventor: Kouji Yoshida, Adachi-ku (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Nikon Corporation, Chiyoda-ku (JP)

(21) Appl. No.: 09/809,093

(22) Filed: Mar. 16, 2001

(30) Foreign Application Priority Data
Mar. 17, 2000 (JP) 2000-075050

(51) Int. Cl. G01B 11/00

(52) U.S. Cl. 356/401

(57) ABSTRACT

An extracting unit extracts a domain regarding the relative position between a predetermined template and an observation result to be obtained by observing a mark by using an observing unit in which the distribution of correlation coefficients between the observation result and the predetermined template has a single peak from the observation result. A search unit obtains the positional relationship between the predetermined template and the observation result in which the correlation coefficient between the predetermined template and the observation result is maximum in the extracted domain by using a hill climbing method. Based on the obtained positional relationship, a position calculating unit can obtains the position of the mark. Consequently, the position of the mark can be detected with high speed and high precision.

### BACKGROUND OF THE INVENTION

1. Field of the Invention

The present invention relates to a position detecting method and apparatus, an exposure method, an exposure apparatus and a manufacturing method thereof, a computer-readable recoding medium, and a device manufacturing method. More particularly, the present invention relates to the position detecting method and apparatus for detecting position information of a mask formed on an object; the exposure method using the position detecting method, the exposure apparatus comprising the position detecting apparatus and making method thereof; the computer-readable recording medium in which programs for controlling the position detecting method to be executed are stored; and the device manufacturing method using the exposure method in a lithographic process.

2. Description of the Related Art

Conventionally, in the lithography process for manufacturing semiconductor devices and liquid crystal devices, etc., an exposure apparatus has been used. In such an exposure apparatus, patterns are formed on a mask or reticle (to be generally referred to as a “reticle”, hereinlater) are transferred through a projection optical system onto a substrate such a wafer or glass plate (to be referred to as a “substrate or wafer”, hereinlater, as needed) coated with a resist or the like. As such an exposure apparatus, a static exposure type projection exposure apparatus such as a so-called stepper, or scanning exposure type one such as a so-called scanning stepper is generally used.

In these exposure apparatuses, prior to exposure, the positioning of the reticle and the wafer (alignment) must be precisely performed. In order to perform the alignment, position detection marks formed in the above-mentioned lithographic process, i.e., alignment marks formed by exposure transfer, are associated to each shot area. Therefore, the position of the wafer or the circuit pattern on the wafer might be detected by detecting the alignment mark. Then, the alignment is performed by using the detection result of the position of the wafer or the circuit pattern on the wafer.

Accordingly, the precision of alignment is determined by position detecting precision of the alignment mark. In order to perform the alignment with high precision, it is necessary to precisely detect the position of the alignment mark.

Some methods for detecting the position of the alignment mark on the wafer are put into practice use. According to any method thereof, a waveform of a detected result signal of the alignment mark to be obtained by a detector for detecting the position is analyzed, and the position of the alignment mark on the wafer is detected. For example, in image detection which has been mainly used in recent years, an optical image of the alignment mark is photographed by an image pick-up unit, the distribution of light intensities of the image pick-up signal, i.e., the image is analyzed, and the position of the alignment mark is detected.

As such an analysis method for the signal waveform, attention is paid to a pattern matching method (template matching method) where the position of the photographed alignment mark is set as a parameter and the correlation with a template waveform to be prepared is checked. By using this pattern matching method, the signal waveform is analyzed and a parameter value having the highest correlation with the template waveform is obtained, thereby detecting the position of the alignment mark.

In the aforementioned template matching method, since the location of the mark image in the image pick-up result is generally unknown, a scanning search method has been used; the correlation coefficient is calculated by relatively moving the template waveform and a signal waveform to be obtained from the image pick-up result at pitches having desired position detecting precision throughout the overall range of the image pick-up result and the position having a maximum correlation coefficient at the foregoing position detecting precision is detected as the position of the alignment mark.

According to the above conventional position detecting method of the alignment mark, the image of the alignment mark is picked up within a range including a part of the alignment mark. Herein, the characteristics necessary for the position detection of the alignment mark are the arrangement of line patterns in the X-direction in the case in which an alignment mark for detecting an X-position is a line and space mark to be formed by alternately aligning a line pattern and space pattern extending in the Y-direction in the X-direction. Therefore, the picked-up image range of the line and space mark for detecting the X position may have a width smaller in the Y-direction than the width of the line and space mark in the Y-direction. However, the range in the X-direction is varied depending on the precision of pre-measurement to determine the image pick-up position, and is set to have a width much larger than that in the X-direction of the line and space mark. That is, the image pick-up result of the line and space mark for detecting the X position covers a wide area in the X-direction including the area of the line and space mark.

On the other hand, because it is not known in advance at which X position within the image pick-up range the line and space mark for detecting the X position is positioned, the pattern matching was performed throughout the overall image pick-up range in the X-direction of the image pick-up range. If it is assumed that a width of the image pick-up range in the X-direction is P (e.g., 500) pixels and a desired position detecting precision is 1/Q (e.g., 1/100) pixel, a normalized correlation-coefficient must be calculated at P.Q (e.g., 5×10⁴) times. As a consequence, the amount of calculation for the pattern matching was numerous and this resulted in requiring a long time for detecting the position.

Also, according to the conventional position detecting method using the template matching method, in order to increase the position detecting precision by K times, the throughput for detecting the position is decreased to 1/K. Therefore, it is difficult to establish both the improvement of the position detecting precision and the suppression of decrease in throughput for detecting the position. In fields in which both precision and throughput are emphasized such as an exposure apparatus, this technique can hardly be used.

This situation is also applied not only to the above-mentioned line and space mark for detecting the X position but also to the line and space mark for detecting the Y position. Further, this situation is applied to the case of adopting other marks for detecting the position.

### SUMMARY OF THE INVENTION

The present invention has been made in consideration of the above situation, and has the first object to provide a mark detecting method and a mark detecting apparatus capable of detecting a mark position with high speed and high precision.

It is the second object of the present invention to provide an exposure method and an exposure apparatus capable of exposure with high speed and high precision.

It is the third object of the present invention to provide a device manufacturing method capable of producing a high-integrated device having a fine pattern.

According to the first aspect of the present invention, there is provided a position detecting method for detecting position information of a mark-formed on an object, comprising: observing the mark; extracting a domain, which reflects the mark and in which a distribution of correlation coefficients obtained by a template matching method for an observation result of the mark using a predetermined template has a single peak, from the observation result; obtaining a positional relationship, in which the correlation coefficient is maximum in the domain, between the predetermined template and the observation result by using a hill climbing method; and detecting position information of the mark based on the obtained positional relationship. In this specification, the correlation coefficient means the value of a cross-correlation function ( the correlation value ).

According to this method, with respect to the observation result obtained by observing the mark, an extracted area is a domain regarding the relative position between the predetermined template and the observation result, at which the distribution of correlation coefficients for the observation result using the predetermined template has the single peak (namely, a local optimization solution becomes a global optimization solution). In other words, this distribution is a uni-modal distribution in the domain. A subsequent process is to obtain the positional relationship between the predetermined template and the observation result by using the hill climbing method, at which the correlation coefficient between the predetermined template and the observation result becomes maximum in the extracted domain. Then, based on the obtained positional relationship, the position information of the mark is detected. In the position detecting process, in the case of searching the positional relationship having the maximum correlation coefficient by using the hill climbing method, the number of calculating times of the correlation coefficient is approximately log₂(P′.Q) minimum and it is (P′.Q) maximum, for instance, when a width of the domain is P′-pixel and a desired position detecting precision is 1/Q-pixel. Accordingly, the number of calculating times of the correlation coefficient can further be lessened as compared with that according to the conventional method, thus enabling the position of the mark to be detected with high speed and high precision.

According to the position detecting method of the present invention, when the mark is associated with an mark-outside area whose surface state has characteristics different from those of another area and which is outside of a mark-formed area in a predetermined direction, a characteristic amount is obtained corresponding to the characteristics at each position of a window which has a size corresponding to the mark-outside area, based on the observation result of the window, while scanning the window. In this specification, the mark-outside area means the predetermined outside of the mark area. Based on change of the characteristic amount corresponding to the position of the window, the domain can be extracted. For example, when the mark-outside area is within a pattern-forbidden band, a window having a size corresponding to a width in a predetermined direction of the pattern-forbidden band is set, and based on the observation result in the window, a scanning position of the window at which the characteristics of the pattern-forbidden band are most remarkable is obtained by scanning the window in the predetermined direction. Thereby, the domain in the observation area can be extracted.

According to the position detecting method of the present invention, when the mark has an mark-inside area whose surface state has characteristics different from those of another area and which is in a mark-formed area in a predetermined direction, a characteristic amount corresponding to characteristics of the surface state in the mark-inside area is obtained at each position of a window having a size corresponding to the mark-inside area, from the observation result in the window, while scanning the window. In this specification, the mark-inside area means the predetermined inside of the mark area. Based on change of the characteristic amount corresponding to the position of the window, the domain can be extracted. For example, when the surface state is markedly changed in the predetermined direction throughout the overall range of the mark-formed area, a window having a size corresponding to a width in the predetermined direction of a mark signal area is set, and based on the measurement result in the window, the scanning position of the window, at which the degree of the change of the measurement result in the window becomes a local maximum (or maximum), is obtained by scanning the window in the predetermined direction. Thereby, the domain can be extracted in the observation area.

According to the above position detecting method for extracting the domain while scanning the window of the present invention, the characteristic amount can be at least one of an average and a variance of the observation result in the window. For example, when the aforementioned pattern-forbidden band exists, the value of a measurement signal is an approximately predetermined value in a signal area which reflects the pattern-forbidden band. In this case, when the value of the measurement signal reflecting the pattern-forbidden band has characteristics that it is averagely larger or smaller as compared with another area, the pattern-forbidden band can be extracted and the mark-formed area can also be extracted by paying attention to an average of the values as the measurement result in the window. Because the measurement signal reflecting the pattern-forbidden band takes an approximately constant value, the variance of the values of the measurement signals in the case of including only a measurement area reflecting the pattern-forbidden band in the window is smaller than that in the case of including the other area in which the pattern is formed. Accordingly, the pattern-forbidden band can be extracted and the domain can also be extracted by paying attention to the variance of the values as the measurement result in the window.

According to the position detecting method of the present invention, the hill climbing method can be a simplex method in which an evaluation function is the correlation coefficient. In this case, it is possible to obtain the positional relationship between the observation result of the mark and the predetermined template in which the correlation coefficient becomes maximum by using the simplex method as a general and simple method.

According to the second aspect of the present invention, there is provided a position detecting apparatus for detecting position information of a mark-formed on an object, comprising: an observing unit which observes the mark; an extracting unit which extracts a domain which includes an observation result by the observing unit that reflects the mark and in which a distribution of correlation coefficients obtained by a template matching method for the observation result of the mark using a predetermined template has a single peak, from the observation result; a search unit which obtains a positional relationship, in which the correlation coefficient is maximum in the domain, between the predetermined template and the observation result by using a hill climbing method; and a position calculating unit which detects a position of the mark based on the positional relationship obtained by the search unit.

According to this apparatus, with respect to the observation result obtained by observing the mark by the observing unit, the extracting unit extracts the domain regarding the relative position, in which the distribution of correlation coefficients for the observation result using the predetermined template has the single peak, between the predetermined template and the observation result. The search unit obtains the positional relationship, in which the correlation coefficient between the predetermined template and the observation result is maximum in the extracted domain, between the predetermined template and the observation result by using the hill climbing method. Based on the obtained positional relationship, the position calculating unit obtains the position of the mark. In other words, according to the position detecting apparatus of the present invention, the position of the mark is detected by using the position detecting method of the present invention. Thereby, the position of the mark can be detected with high speed and high precision.

According to the position detecting apparatus of the present invention, for example, the observing unit has an image pick-up unit which picks up an image of a mark-formed on the object, and the observation result can be light intensity of the mark image which is picked up by the image pick-up unit.

According to the position detecting apparatus of the present invention, the extracting unit scans a window having a size corresponding to a specific area whose surface state on the object has characteristics different from those of another area, obtains a characteristic amount corresponding to the characteristics at each position, from the observation result in the window, and extracts an area having the observation result that reflects the mark, based on changes of the characteristic amount corresponding to the positional change of the window. In this case, the extracting unit calculates the characteristic amount in the window, while scanning the window having the predetermined size, and obtains the distribution of the characteristic amount corresponding to the position of the window. The position of the window, at which has the most characteristic value is obtained, thereby extracting the domain to which the single peak of the correlation coefficients is ensured. Thus, it is possible to fast extract the positional relationship, in which the correlation coefficient becomes maximum, between the template and the observation result, and also to detect the position of the mark with high speed and high precision.

Herein, the surface state includes a state of light from the surface of the object. In other words, the surface state includes not only an uneven shape, etc. of the surface but also reflectance distribution on the surface, etc. Further, the surface state includes transmittance distribution in the case of using a transmission-type mark.

According to the third aspect of the present invention, there is provided an exposure method for transferring a predetermined pattern onto a plurality of divided areas on a substrate, comprising: detecting a position of a position detection mark which is formed on the substrate by using the position detecting method of the present invention, obtaining, with respect to the position of the divided area, a parameter of a predetermined number, and calculating arrangement information of the divided area on the substrate; and transferring the pattern onto the divided area by controlling the position on the substrate on the basis of the arrangement information of the obtained divided area.

According to this method, in the position calculation, the position of the position detection mark formed on the substrate is detected with high speed and high precision by using the position detecting method of the present invention, and the position information of the divided area on the substrate is calculated based on the detection result. In the transfer, the alignment of the substrate is performed on the basis of the position information of the divided area and, simultaneously, the pattern is transferred onto the divided area. Accordingly, the predetermined pattern can be transferred onto the divided area with high speed and high precision.

According to the fourth aspect of the present invention, there is provided an exposure apparatus for transferring a predetermined pattern onto a plurality for divided areas on a substrate, comprising: a stage unit which moves the substrate along a moving surface; and the position detecting apparatus of the present invention which detects a position of a mark on the substrate that is mounted onto said stage unit. According to this apparatus, it is possible to precisely detect not only the position of the mark on the substrate but also the position of the substrate by using the position detecting apparatus of the present invention. Therefore, the stage unit can move the substrate based on the position of the substrate which is precisely obtained. As a consequence, the predetermined pattern can be transferred onto the divided area on the substrate with high speed and high precision.

According to the fifth aspect of the present invention, there is provided a manufacturing method of an exposure apparatus for transferring a predetermined pattern onto a divided area on a substrate, comprising: providing a stage unit which moves the substrate along a moving surface; and providing a position detecting apparatus which detects position information of a mark on the substrate that is mounted onto the stage unit, wherein the position detecting apparatus comprises: an observing unit which observes the mark; an extracting unit which extracts a domain, which includes an observation result by the observing unit that reflects the mark and in which a distribution of correlation coefficients obtained by a template matching method for the observation result using a predetermined template has a single peak, from the observation result; a search unit which obtains a positional relationship, in which the correlation coefficient is maximum in the domain, between the predetermined template and an image pick-up result by using a hill climbing method; and a position calculating unit which calculates the position information of the mark based on the positional relationship obtained by the search unit.

According to this method, the stage unit which moves the substrate along the moving surface is provided. The position detecting unit which detects the position information of the mark on the substrate that is mounted onto the stage unit is provided. Also, the exposure apparatus is manufactured by combining other various parts mechanically, optically, and electrically and adjusting them.

Incidentally, when the position detecting apparatus is constructed as a computer system, the computer system reads out a control program from a recording program in which a control program for controlling the execution of the position detecting method of the present invention is stored, and executes the position detecting method of the present invention. Thereby, the position can be detected by the position detecting method of the present invention. Accordingly, the present invention is a control program which controls the use of the position detecting method of the present invention.

In the lithography process, by performing exposure using one of the exposure methods of the present invention, fine patterns having a plurality of layers can be overlaid on the substrate and can be formed precisely. As a consequence, the yield of micro-devices as final products improves, and the productivity can be improved. Therefore, according to still another aspect of the present invention, there is provided a device manufacturing method using one of the exposure methods of the present invention.

### BRIEF DESCRIPTION OF THE DRAWINGS

In the accompanying drawings:

FIG. 1 is a view showing the schematic arrangement of an exposure apparatus according to an embodiment of the present invention;

FIGS. 2A and 2B are views for illustrating an example of a position detection mark;

FIGS. 3A to 3C are views for illustrating image pick-up results of alignment marks in FIG. 2B;

FIGS. 4A to 4E are views for explaining the process for forming the mark through a CMP process;

FIG. 5 is a view showing the schematic arrangement of a main control system;

FIG. 6 is a flowchart for illustrating a position detecting operation of the mark;

FIGS. 7A and 7B are views for illustrating image pick-up results for the alignment marks according to the embodiment;

FIG. 8 is a conceptual view for illustrating a one-dimensional filter according to the embodiment;

FIG. 9 is a graph showing a distribution of signal intensities in a window of the one-dimensional filter in FIG. 8;

FIG. 10 is a flowchart for illustrating a subroutine for position calculation in FIG. 6;

FIGS. 11A and 11B are views for illustrating a process for position calculation;

FIG. 12 is a flowchart for illustrating a subroutine for calculation of a new parameter-value in FIG. 10;

FIGS. 13A and 13B are views for illustrating the process for position calculation;

FIGS. 14A and 14B are views for illustrating a modification using a differentiating waveform;

FIGS. 15A and 15B are views for illustrating a modification using a one-dimensional filter having a window corresponding to a mark signal area;

FIGS. 16A to 16D are views for illustrating modifications using a two-dimensional mark;

FIGS. 17A and 17B are views for illustrating a modification using the two-dimensional mark;

FIG. 18 is a flowchart for illustrating a device manufacturing method using the exposure apparatus in FIG. 1; and

FIG. 19 is a flowchart for a process in wafer processing step in FIG. 18.

### DESCRIPTION OF THE PREFERRED EMBODIMENTS

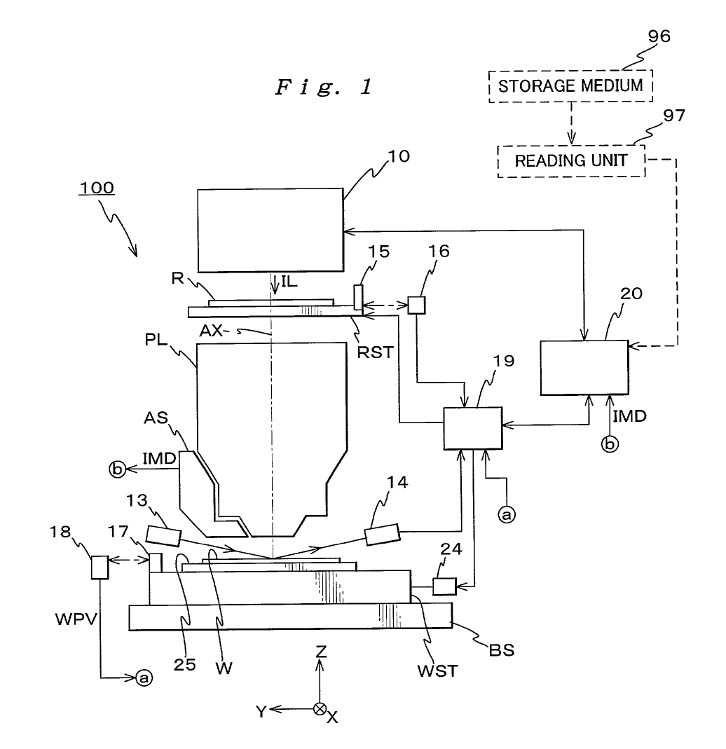

An embodiment of the present invention will be described below with reference to FIGS. 1 to 13B.

FIG. 1 shows the schematic arrangement of an exposure apparatus 100 according to the embodiment of the present invention. The exposure apparatus 100 is a projection exposure apparatus based on a step-and-scan method. The exposure apparatus 100 comprises: an illumination system 10; a reticle stage RST for holding a reticle R as a mask; a projection optical system PL, a wafer stage WST as a stage unit on which a wafer W as a substrate (object) is mounted; an alignment system AS as an observing unit (image pick-up unit); and a main control system 20 for systematically controlling the overall apparatus, etc.

The illumination system 10 includes: a light source; an illumination averaging optical system composed of a fly-eye lens, etc.; a relay lens; a variable ND filter; a reticle blind; and an diachronic mirror (all of which are not shown in Figs.). The similar-structured illumination system is disclosed in, for example, Japanese Unexamined Patent Application Publication No. 10-112433. The disclosure described in the above is fully incorporated by reference herein. In the illumination system 10, illumination light IL illuminates an illumination area with slit form defined by the reticle blind on the reticle R on which a circuit pattern is drawn.

The reticle R is fixed on the reticle stage RST, for instance, by vacuum chucking. In order to position the reticle R, the reticle stage RST is driven by a reticle stage driving unit composed of two-dimensional magnetic floating-type linear actuator, which is not shown in Figs. The reticle stage RST is structured so that it can be finely driven in the X-Y plane which is perpendicular to an optical axis AX of the illumination system 10 (the optical axis AX is coincident with another optical axis AX of the optical projection system PL described in below), and it can move to the predetermined direction with designated scanning velocity, wherein it is the Y-axis direction. Furthermore, in the present embodiment, since the above-mentioned two-dimensional magnetic floating-type linear actuator includes a coil for driving RST in Z-direction except two coils for driving RST in the X-direction and Y-direction so that the linear actuator can finely drive RST in the Z-direction.

A reticle laser interferometer (to be referred to as a “reticle interferometer”, hereinlater) 16 detects the position of the reticle stage RST within the stage moving plane at all times via a moving mirror 15 with resolution of, e.g., about 0.5 to 1 nm. Position information of the reticle stage RST is transmitted from the reticle interferometer 16 to a stage control system 19. The stage control system 19 drives the reticle stage RST through a reticle driving portion (not shown in Figs.) based on the position information of the reticle stage RST.

The projection optical system PL is arranged below the reticle stage RST in FIG. 1. The direction of the optical axis AX of the projection optical system PL is the Z-axis direction. As the projection optical system PL, a refraction optical system is used, which is both-sided telecentric, and having a predetermined projection magnification of, for instance, ⅕ or ¼. Therefore, when the illumination area of the reticle R is illuminated with the illumination light IL from the illumination optical system, a reduced image (partial inverted image) of the circuit pattern of the reticle R in the illumination area is formed on the wafer W, of which surface is coated with a photo-resist, via the projection optical system PL by the illumination light IL which passes through the reticle R.

The wafer stage WST is arranged below the projection optical system PL in FIG. 1, and on a base BS. A wafer holder 25 is mounted on the wafer stage WST. The wafer W is fixed onto the wafer holder 25 by the vacuum etc., the wafer holder 25 is so structured by a drive portion not shown ) that it can be tilted in the arbitrary direction against the orthogonal plane of the light axis of the projection optical system PL, and can be finely driven to the AX direction of the light axis AX of the projection optical system PL (Z-direction). Also, the wafer holder 25 can finely be driven around the AX direction.

The wafer stage WST is structured to be capable of being moved in the perpendicular direction to the scanning direction (X-direction) so that a plurality of shot areas on the wafer W are also moved in the scanning direction (Y-direction) to be positioned in the exposure area which is conjugate to the above-mentioned illumination area. The wafer stage WST performs so-called step-and-scan operation motion in which the scanning exposure of the shot area on the wafer W and moving to the exposure starting position of the next shot area are repeated. The wafer stage WST is driven in the XY-two dimensional direction by using a wafer stage driving portion 24.

The wafer interferometer 18 is arranged to detect the position of the wafer stage WST in the X-Y plane through the moving mirror 17 at all times with the resolution of, for example, about 0.5 to 1 nm. Position information or velocity information WPV of the wafer stage WST is transmitted to a stage system 19. The stage control system 19 drives the wafer stage WST by using the position information WPV of the wafer stage WST. The position information WPV of the wafer stage WST is transmitted to the stage control system 19. The stage control system 19 controls the wafer stage WST based on the position information or velocity information WPV.

The above-mentioned alignment system AS is an off-axis alignment sensor arranged at the side of the projection optical system PL. The alignment system AS outputs the picked-up image of the alignment marks (wafer marks) located in each shot area on the wafer W.

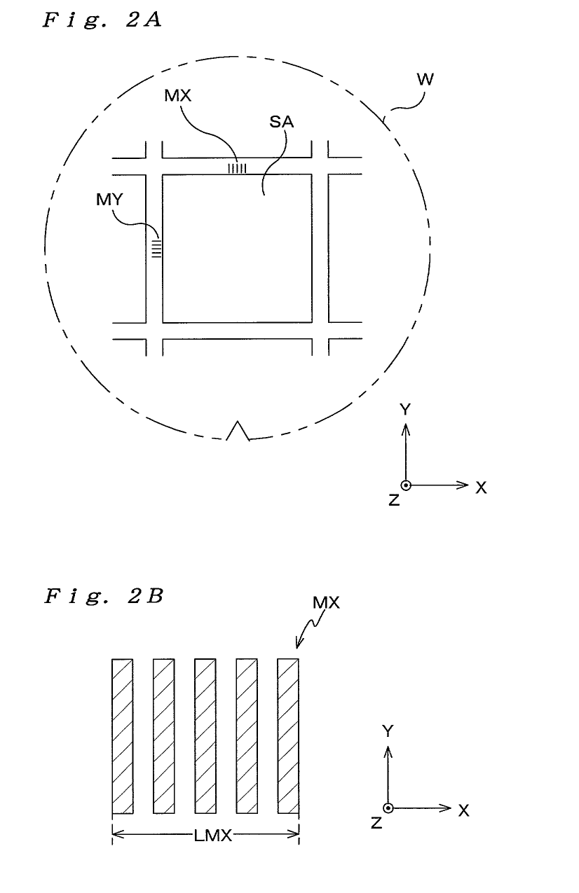

For example, a mark MX for detecting the position in the X-direction and a mark MY for detecting the position in the Y-direction to be formed onto a street line around a shot area SA on the wafer W shown in FIG. 2A are used as alignment marks. As each of the marks MX and MY, it is possible to use a line and space mark having a periodic structure in the detecting direction and a width LMX (LMY in the case of the mark MY) in the detecting direction as representatively shown by a mark MX in an enlarged plane-view in FIG. 2B. Although a line and space mark having five lines is shown in FIG. 2B, the number of lines in the line and space mark adopted as the mark MX (or mark MY) is not limited to the five lines and any number of lines may be used. In the following description, it is assumed that when the individual marks MX and MY are shown, those are shown by a mark MX (i, j) and a mark MY (i, j) in accordance with the arrangement position of the corresponding shot area SA.

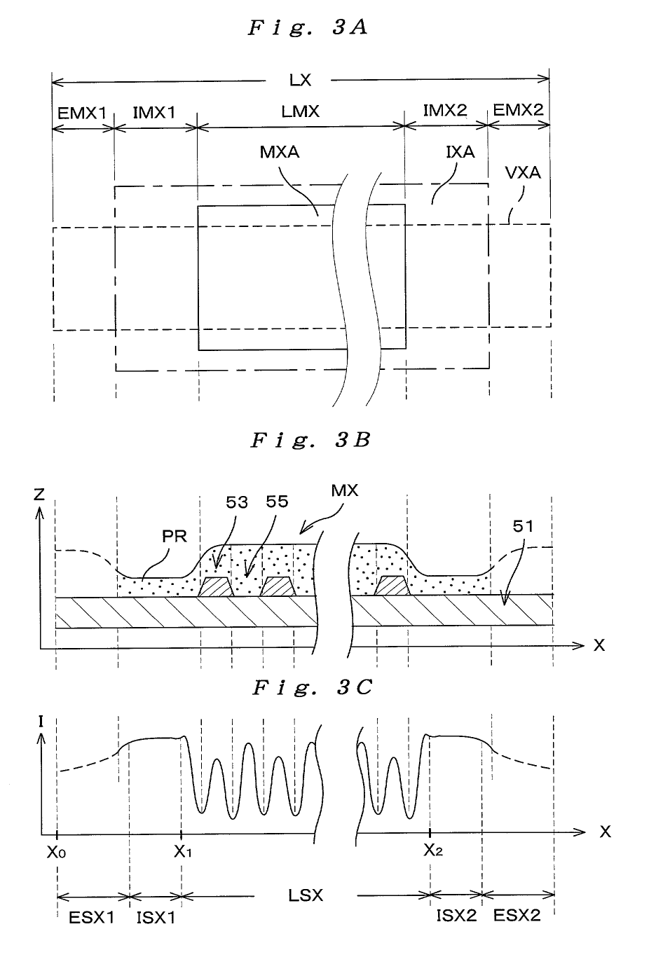

The above-described mark MX is formed in a mark-formed area MXA shown in FIG. 3A as an mark-inside area and a pattern-forbidden area IXA shown in FIG. 3A is provided around the mark-formed area MXA so as to make it possible to discriminate a pattern of the mark MX from other patterns. Herein, the pattern-forbidden area IXA has a width IMX1 in the X-direction at the left of the mark-formed area MXA shown in FIG. 3A and a width IMX2 in the X-direction at the right of the mark. The width IMX1 and the width IMX2 are determined at the design time of the mark and have given values which are much larger than the line width and space width of the mark MX.

In the alignment system AS, the mark MX includes a mark-formed area MXA and the pattern-forbidden area IXA in the X-direction, and is observed as an image in a field area VXA having a width LX in the X-direction which corresponds to a measurement area. In FIG. 3A, it is assumed that reference numeral EMX1 denotes the width of the field area VXA outside the pattern-forbidden area IXA at the left in the figure and reference numeral EMX2 denotes the width of the field area VXA outside the pattern-forbidden area IXA at the right in the figure. Incidentally, the widths EMX1 and RMX2 change every observation of the mark MX and are unknown values upon observation of the mark MX.

Although FIG. 3A shows an example in which the width in the Y-direction of the field area VXA is included in the width in the Y-direction of the mark-formed area MXA, at least the center area in the Y-direction of the field area VXA should be included in the width in the Y-direction of the mark-formed area MXA.

In the present embodiment, as representatively shown by the mark MX in XZ cross-section in FIG. 3B, the marks MX and MY on the wafer W are constructed by alternately forming a line portion 53 on which a line pattern is formed onto a basic layer 51 and a space portion 55 on which the pattern is not formed onto the basic layer 51 in the X-direction and a resist layer PR is formed onto the line portion 53 and the space portion 55. The material of the resist PR is, for example, a chemical-amplification-type resist having a high optical transmissivity. The material of the basic layer 51 is different from that of the line pattern, and is having a higher reflectance than that of the line pattern.

Similarly to the space portion 55, the resist layer PR is formed onto the basic layer 51 in the pattern-forbidden area IXA. The state in the area outside the pattern-forbidden area IXA is in a predetermined state.

The XZ cross-section is not completely rectangular-shaped and trapezoid-shaped as shown in FIG. 3B. Further, the resist layer PR is coated by a spin coat method. Thereby, the surface of the resist layer PR in the mark-formed area MXA in which a convex pattern (line pattern) is formed on the basic layer 51 is protuberant from the surface of the resist layer PR in the pattern-forbidden area IXA with a trapezoid shape.

FIG. 3C shows a distribution of light intensities in the X-direction obtained by an image pick-up of the mark MX with the above structure in the field area VXA. In other words, in the area corresponding to the mark-formed area MXA, a signal intensity I is locally minimized at the boundary between the mark portion and the space portion, and the signal intensity I is locally maximized at the individual centers of the mark portion 53 and the space portion 55 in the X-direction. At the boundary between the mark-formed area MXA and the pattern-forbidden area IXA, the signal intensity I is locally minimized because the boundary coincides with an edge of the line potion 55. The signal intensity I increases as an X-position is farther from the boundary between the mark-formed area MXA and the pattern-forbidden area IXA, and it becomes an approximately constant value (approximately maximum) when the X-position is far by more than a certain distance. Further, when the X-position is far from the boundary between the mark-formed area MXA and the pattern-forbidden area IXA and approaches the external periphery of the pattern-forbidden area IXA, and besides if ,for example, the line pattern is formed outside of the pattern-forbidden area IXA, the signal intensity I starts to decrease.

That is, since no pattern is formed in the pattern-forbidden area IXA, ideally, the signal intensity I should have an approximately single value throughout the pattern-forbidden area IXA. However, the pattern shape and the resist layer PR are not uniform and, therefore, widths ISX1 and ISX2 are narrower than the widths IMX1 and IMX2 of the pattern-forbidden area on the design, respectively. The widths ISX1 and ISX2 denote widths of the range in which the signal intensity I is constant corresponding to characteristics of the pattern-forbidden area such that the state of surface where no pattern is formed at all. Note that information on the differences between the width IMX1 and width ISX1 and between the width IMX2 and the width ISX2 is different depending on a forming process of the mark MX, a forming process of the resist layer PR, and a pattern state outside the pattern-forbidden area IXA, however, it is assumed that the information is obtained in advance by design information or pre-measurement. Namely, it is assumed that reference numeral LSX denotes a width in the X-direction of a signal area (hereinlater, referred to as “mark signal area”) reflecting the state of surface of the mark-formed area MXA and is known, and the widths ISX1 and ISX2 also denote widths in the X-direction in a signal area (hereinlater, referred to as “forbidden band signal area”) reflecting the state of surface of the pattern-forbidden area IXA and are known.

Accordingly, widths ESX1 and ESX2 in FIG. 3C are unknown numbers on the extraction of the mark signal area in the field area VXA.

The pattern-forbidden area similar to that of the mark MX is also provided in the mark MY and is also observed in the same manner as that of the mark MX.

The alignment system AS outputs image pick-up data IMD of the field area VXA as the image pick-up result to the main control system 20 (refer to FIG. 1).

Recently, the fine pattern of semiconductor circuits has resulted in the use of a process for flattening surfaces of layers which are formed on the wafer W so as to form a fine circuit pattern with higher precision (flattening process). The typical process is a CMP process (Chemical and Mechanical Polishing process) in which the surface of a formed film is polished and the surface of the formed film is fully flattened. This CMP process is frequently applied to an interlayer between wire layers (metal) of a semiconductor integrated circuit (dielectric such as silicon dioxide).

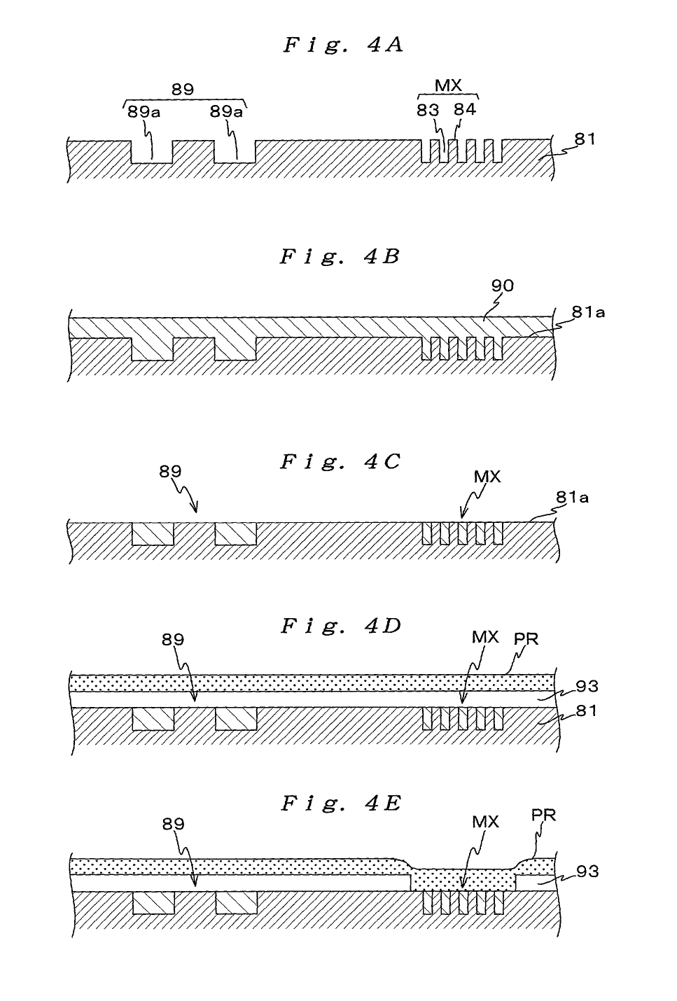

In the current developing processes, there is, for instance, an STI (Shallow Trench Isolation) process in which a groove having a shallow predetermined-width is formed to insulate adjacent fine elements and an insulation film such as a dielectric is embedded in the groove. In the STI process, the surface of a layer in which an insulating material is embedded is flattened in the CMP process and poly-silicon is thereafter formed onto the resultant surface. A description is given of an example for the case of forming not only the mark MX obtained by formed in the above-mentioned process but also other patterns with reference to FIGS. 4A to 4E.

First of all, as shown in the cross-sectional view of FIG. 4A, a mark MX (concave portion corresponding to a line potion 83 and a space potion 84) and a circuit pattern 89 (more specifically, concave portion 89a) are formed on a silicon wafer (basic material) 81.

Next, as shown in FIG. 4B, an insulation film 90 containing a dielectric such as silicon dioxide (SiO₂) is formed on a surface 81a of the wafer 81. Subsequently, as shown in FIG. 4C, the CMP process is applied on the surface of the insulation film 90 to remove the insulation film 90 so that the surface 81a of the wafer 81 appears and is flattened. As a result, the circuit pattern 89 is formed in the circuit pattern area, and the insulation film 90 is embedded in the concave portion 89a of the circuit area. The mark MX is formed in the mark MX area, and the insulation film 90 is embedded in the plurality of line portions 83.

Then, as shown in FIG. 4D, a poly-silicon film 93 is formed onto the upper layer of the wafer surface 81a of the wafer 81. On the poly-silicon film 93, photoresist PR is coated.

The concave and convex, which reflect the structure of the mark MX formed in the under layer, is not entirely formed on the surface of the poly-silicon layer 93, when the mark MX formed on the wafer 81 as shown in the FIG. 4D is observed by using the alignment system AS. Luminous flux with a predetermined wave range (visible light of which wave length is 550 to 780 nm) does not pass through the poly-silicon layer 93. Therefore, the mark MX might not be detected by using the alignment manner, which uses the visible light as the detection light for the alignment. Also, there is a danger about the alignment manner that the detection accuracy might be decreased by the decrease of the amount of the detection light in the case of the alignment where the major part of the detection light is the visible light.

In FIG. 4D, the metal film (metal layer) 93 might be formed instead of the poly-silicon layer 93. In this case, the concave and convex which reflect the alignment mark-formed in the under layer is not entirely formed on the metal layer 93. In general, since the detection light for the alignment does not pass though the metal layer, there is a danger that the mark MX cannot be detected.

As mentioned above, when observing the wafer 81 on which the poly-silicon layer 93 is formed (shown in FIG. 4D) by using the alignment system AS, the mark MX can be observed, after a wavelength of the alignment detection light is set to detection light having a wavelength other than the visible light (for example, the infrared rays of which wavelength is 800 to 1500 nm) if the wavelength of the alignment detection light is changeable, selectable or optionally set.

When the wavelength of the alignment detection light cannot be selected or the metal layer 93 or poly-silicon layer 93 is formed on the wafer 81 through the CMP process, as shown in FIG. 4E, after an area of the metal layer 93 corresponding to the mark MX is peeled off by using photolithography, the area can be observed by the alignment system AS.

The mark MY can also be formed in the same manner as the above-mentioned mark MX via the CMP process.

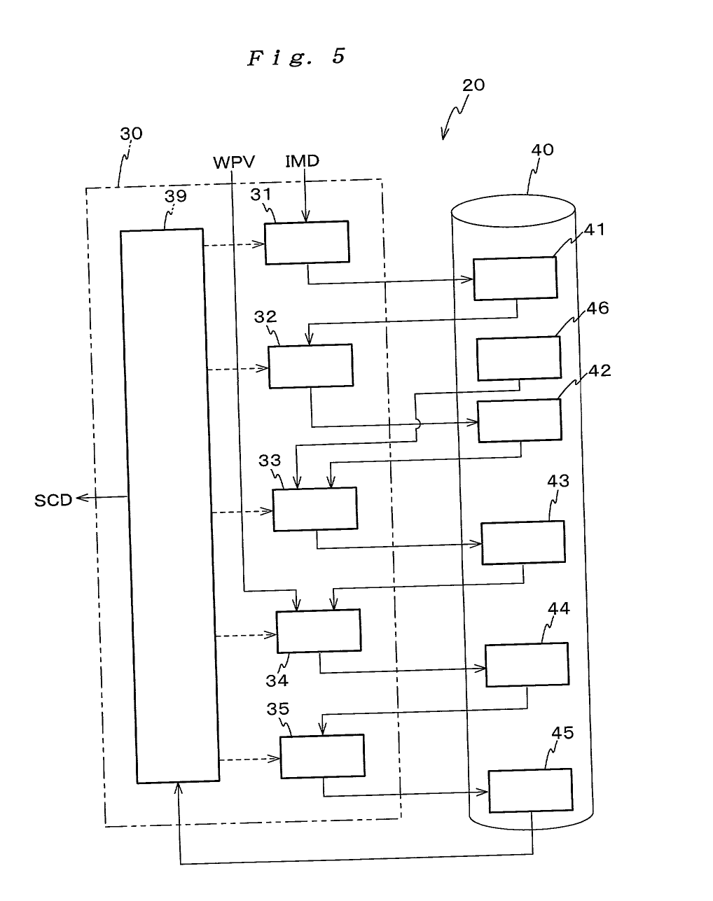

As shown in FIG. 5, the main control system 20 comprises a main control unit 30 and a storage unit 40. The main control unit 30 comprises: a control unit 39 for controlling the operation of the exposure apparatus 100 by transmitting stage control data SCD to the stage control system 19; an image pick-up data collecting unit 31 for collecting the image pick-up data from the alignment system AS; and an extracting unit 32 for extracting the formed areas of the alignment marks MX and MY whose images are picked up on the basis of the image pick-up data which is collected by the image pick-up data collecting unit 31. Further, the main control unit 30 comprises: a search unit 33 for obtaining the position of the template waveform at which the correlation coefficient between the template waveform and a signal waveform in a domain which is determined by the formed areas of the alignment mark MX and MY to be extracted by the extracting unit 32 becomes maximum (hereinlater, referred to as “maximum correlation position”); a position calculating unit 34 for calculating the positions of the alignment marks MX and MY by using the maximum correlation position which is obtained by the search unit 33; and an error parameter value calculating unit 35 for calculating a parameter value (error parameter) that uniquely prescribes the arrangement of the shot areas SA by using the positions of the alignment marks MX and MY which are calculated by the position calculating unit 34.

The storage unit 40 therein comprises: an image pick-up data storing area 41; an area information storing area 42; and a maximum-correlation-position-storing area 43 for storing the maximum correlation position. Further, the storage unit 40 comprises: a mark position storing area 44 for storing the mark position; a parameter value storing area 45 for storing a position parameter value; and a template storing area 46 for storing a template waveform. Incidentally, in FIG. 5, arrows drawn with solid lines show a data flow, and those drawn with the dotted lines show a control flow. Operation of each component included in the main control system 20 is explained in the latter part.

As mentioned above, in the present embodiment, the main control unit 30 is structured in combination of the various units. However, the main control system 20 might be structured as a computer system, and the function of each unit, which composes the main control unit 30, can be achieved by an installed program in the main control unit 20.

When the main control system 20 is structured as a computer system, it is not necessary to install all programs to achieve the function of the above-mentioned apparatus which structure the main control unit 30. For example, the following structure might be employed: a storage medium 96 in which the program is stored is prepared, it is shown in FIG. 1 as a box with the dotted lines; the storage medium 96 can be inserted into and taken out from a reader unit 97, which is used to read out the contents of the program stored in the medium 96; the reader unit 97 is connected to the main control system 20 to read out the contents of the program from the storage medium 96 inserted into the reader unit 97 to execute the program.

Additional structure may be employed such that the main control system 20 reads out the contents of the program from the storage medium 96 that is inserted into the reader unit 97 to install them in the main control system 20. Furthermore, another structure may be employed to install the contents of the program necessary for achieving the function in the main control system 20 via a communication network by using the Internet, etc.

As the storage medium 96, various kinds of media can be used in which storing of information are varied magnetically (a magnetic disk, magnetic tape, or the like), electrically (PROM, RAM with buttery back-up, EEPROM and other semiconductor memories), magneto-optically (magneto-optical disk, etc.), electro-magnetically (digital-audio tape (DAT), etc.).

As mentioned above, the contents of the program are easily amended, or version up for advancing its performance is also easily carried out, by structuring the system by using the recording medium in which the contents of the program for achieving the desirable function are stored or are installed.

In the exposure apparatus 100, an illumination optical system 13 and a multi focal detection system with oblique incident light method are fixed on a support portion for supporting a projection optical system PL (not shown in Figs.). As such multi focal detection system (13, 14), for example, the similarly structured system as disclosed in, for example, Japanese Unexamined Patent Application Publication No. 6-190423. The stage control system 19 drives a wafer holder 25 in Z-direction and the tilt direction based on the wafer position information from the multi focal detection system (13, 14).

In the exposure apparatus 100 structured as described above, the arrangement coordinate of the shot area on the wafer W is detected as described below. Incidentally, it is assumed that the marks MX and MY have already been formed on the wafer through the process up to the previous layer (e.g., process of the first layer) when the arrangement coordinate of the shot area is detected. Also, assume that the wafer W is loaded to the wafer holder 25 by a wafer loader (not shown in Figs.) and alignment with coarse precision (pre-alignment) has already been performed by movement of the wafer W via the stage control system 19 which is caused by the main control system 20 so as to include the marks MX and MY in the observation field of the alignment system AS (the aforementioned field VXA in the case of the mark MX). The pre-alignment is performed through the stage control system 19 by using the main control system 20, more precisely the control unit 39, based on the observation for the outer shape of the wafer W, the observation result for the marks MX and MY in the wide field, and the position information (or velocity information) from the wafer interferometer 18. Moreover, it is assumed that three or more marks MX (iₘ, jₘ) (m=1 to M; M≧3) for the X-position detection and three or more marks MY(iₙ, jₙ) (n=1 to N; N≧3) for the Y-position detection have been already selected. The above marks MX(iₘ, jₘ) and marks MY(iₙ, jₙ) are not aligned on a single line in terms of design, respectively, and are measured so as to detect the arrangement coordinate of the shot area. Incidentally, the total number (=M+N) of selected marks must be larger than six.

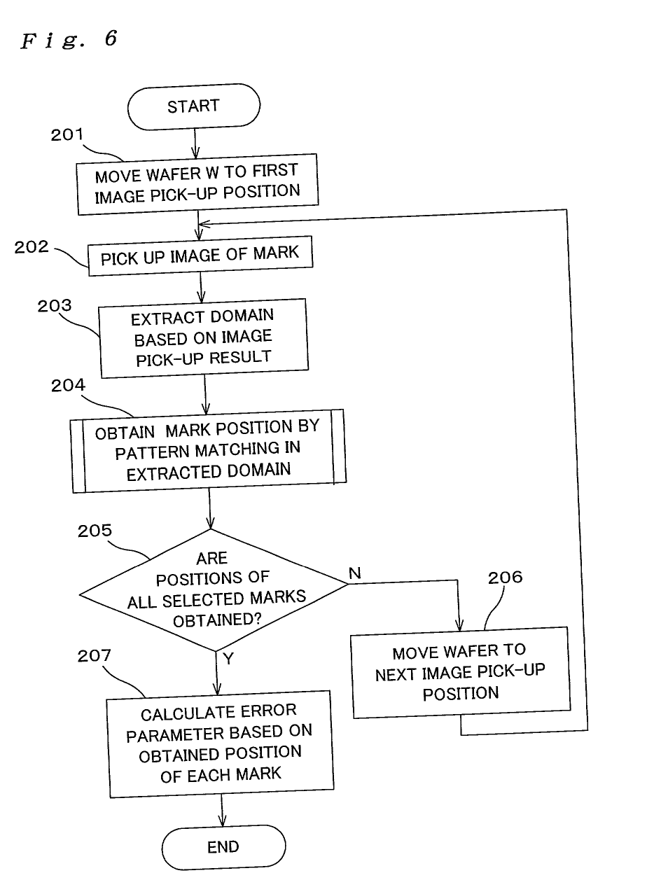

The detection of the arrangement coordinate of the shot area on the wafer W is explained according to the flowchart shown in FIG. 6, referring to other figures suitably.

First of all, in step 201 of the FIG. 6, the wafer W is moved so that the first mark (which is shown by a mark for detecting the X-position MX(i₁, j₁) in the selected marks MX(iₘ, jₘ) and MY(iₙ, jₙ) is set to the image pick-up position for the alignment system AS. The movement of the wafer W is performed under the control operation through the stage control system 19 by using the main control system 20.

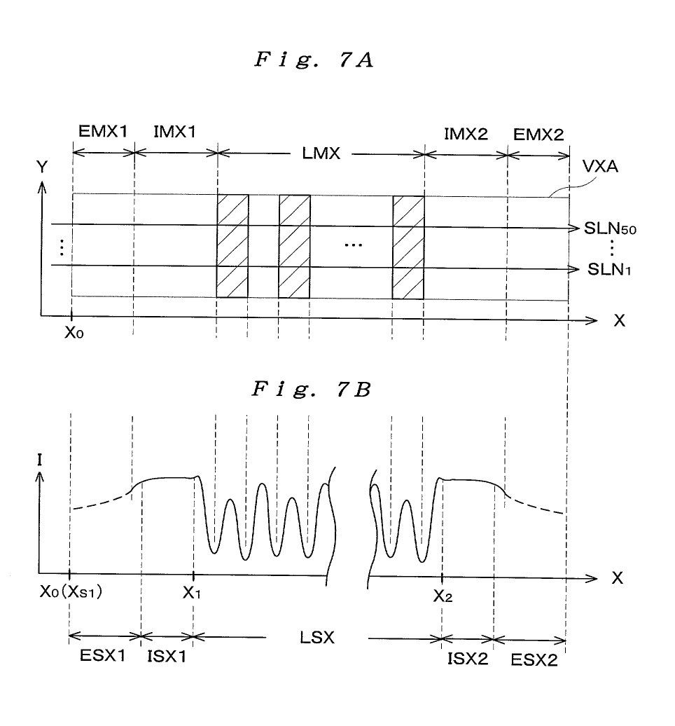

Subsequently, in step 202, the alignment system AS picks up an image of the mark MX(i₁, j₁). When the alignment system AS picks up the image of the mark MX(i₁, j₁) in the condition of the above-explained positional relationship between the mark-formed area MXA and the field area VXA in FIGS. 3A to 3C, the image on the wafer W shown in FIG. 7A is included in the filed area VXA.

As mentioned above, the image pick-up data collecting unit 31 inputs the image pick-up data IMD in the field area VXA as an observation result which is picked up by the alignment system AS in accordance with an instruction from the control unit 39 and stores the input data in the image pick-up data storing area 41, thereby collecting the image pick-up data IMD.

Referring back to FIG. 6, in step 203, the extracting unit 32 reads out the image pick-up data of the mark MX (i₁, j₁) from the image pick-up data storing area 41 in accordance to the instruction from the control unit 39, and extracts the mark-formed area MXA of the mark MX (i₁, j₁) based on the image pick-up data and the position information (or speed information) WPV from the wafer interferometer 18.

In the case of the area extraction, with respect to the image pick-up data of the mark MX(i₁, j₁), first, the extracting unit 32 extracts the signal intensity distribution (distribution of light intensities) I₁(X) to I₅₀(X) on fifty scan lines SLN₁ to SLN₅₀ in the X-direction near the center in the Y-direction of the field area VXA from the image pick-up data storing area 41. Based on the following (1) expression, an average distribution I(X) of signal intensities in the X-direction is obtained as a signal waveform. The distribution I(X) of signal intensities is designated as a signal waveform I(X) hereinbelow.

$$I ( X ) = [ {\sum }_{j = 1}^{50} {I}_{i} ( X ) ] / 50 \qquad ( 1 )$$

The thus-obtained signal waveform I(X) is a waveform that high-frequency noises superimposed on each of the distributions I₁(X) to I₅₀(X) of the signal intensities are reduced. The resultant signal waveform I(X) is shown in FIG. 7B.

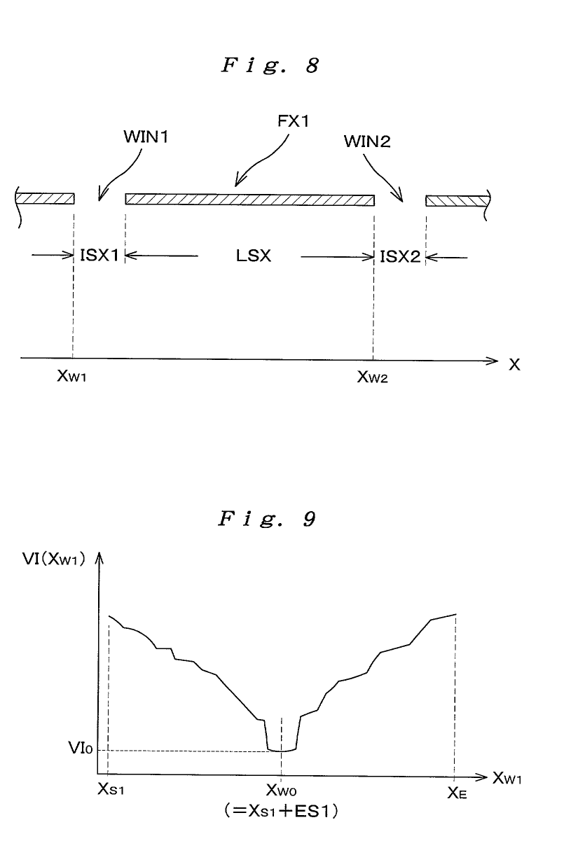

Next, the extracting unit 32 prepares a one-dimensional filter FX1 realized by software in which a window WIN1 having a width ISX1 and a window WIN2 having a width ISX2 are formed apart therebetween by a distance LSX as conceptually shown in FIG. 8. The one-dimensional filter FX1 functions as a filter for picking out only information in the window WIN1 and the window WIN2. Herein, X_{W1} denotes the X-position at one end point in the (−X)-direction of the window WIN1 and X_{W2} denotes the X-position at one end point in the (−X)-direction of the window WIN2. Incidentally, the following relationship is established between the X-position X_{W1} and the X-position X_{W2}.

X_{W2}=X_{W1}+ISX1+LSX (2)

Accordingly, if the X-position X_{W1} determined, the X-position X_{W2} is uniquely determined. Then, it is assumed that the position of the one-dimensional filter FX1 denotes the X-position X_{W1}.

Subsequently, the X-position X_{W1} of the one-dimensional filter FX1 is set to an X-position X₀ at one end in the (−X)-direction in the field are VXA (X-position X_{S1} at the start of scanning), and the one-dimensional filter FX1 is applied to the signal waveform I(X). This results in extracting the signal waveform I(X) (X_{S1 ≦X≦X}_{S1}+ISX1, X_{S1}+ISX1+LSX (=X_{S2})≦X_{S2}+ISX2), via the window WIN1 and window WIN2. With respect to the signal waveform I(X) in the window WIN1 and window WIN2, an average μI(X_{W1}(=X_{S1})), a fluctuation SI(X_{W1}), and a variance VI(X_{W1}) are obtained by the following expressions (3) to (5).

$$\begin{matrix}μ I ( {X}_{W1} ) = \{ {\sum }_{i = 1}^{ISX1} I ( {X}_{W1} + i ) + {\sum }_{j = 1}^{ISX2} I ( {X}_{W2} + j ) \} / ( ISX1 + ISX2 ) & ( 3 ) \\ SI ( {X}_{W1} ) = {\sum }_{i = 1}^{ISX1} {\{ I ( {X}_{W1} + i ) \}}^{2} + {\sum }_{j = 1}^{ISX2} {\{ I ( {X}_{W2} + j ) \}}^{2} & ( 4 ) \\ VI ( {X}_{W1} ) = SI ( {X}_{W1} ) / ( ISX1 + ISX2 ) - {\{ μ I ( {X}_{W1} ) \}}^{2} & ( 5 )\end{matrix}$$

Next, with respect to the signal waveforms in the window WIN1 and the window WIN2 at each X-position X_{W1} of the one-dimensional filter FX1, by moving the X-position X_{W1} of the one-dimensional filter FX1 in the (+X)-direction by one pixel at a time until the one end point of the window WIN2 in the +X-direction coincides with one end point of the field area VXA in the (+X)-direction, the one-dimensional filter FX1 is scanned in the (+X)-direction and, simultaneously, the average μI(X_{W1}), fluctuation SI(X_{W1}) and variance VI(X_{W1}) are calculated. Obviously, the aforementioned expressions (3) to (5) can be used in the case of the calculation of the above average μI (X_{W1}), fluctuation SI (X_{W1}), and variance VI(X_{W1}). Additionally, the relationships represented by the following expressions (6) to (8) are established between the average μI(X_{W1}), fluctuation SI(X_{W1}), and variance VI(X_{W1}) and an average μI(X_{W1}+1), a fluctuation SI(X_{W1}+1), and variance VI(X_{W1}+1).

μI(X_{W1}+1)=μI(X_{W1})+[{I(X_{W1}+ISX1)−I(X_{W1})}+{I(X_{W2}+ISX2)−I(X_{W2})}]/(ISX1+ISX2) (6)

SI(X_{W1}+1)=SI(X_{W1})+[{I(X_{W1}+ISX1+1)}²−{I(X_{W1})}²]+[{I(X_{W2}+ISX2+1)}²−{I(X_{W2})}²] (7)

VI(X_{W1}+1)=SI(X_{W1}+1)/(ISX1+ISX2)−{μI(X_{W1}+1)}² (8)

Then, in the present embodiment, by using the above expressions (6) to (8), the average μI(X_{W1}), fluctuation SI(X_{W1}), and variance VI(X_{W1}) (X_{W1}>X_{S1}) are calculated with the smaller number of calculation as compared with that of the case of using the expressions (3) to (5).

When the X-position X_{W1} of the one-dimensional filter FX1 is given by the following,

X_{E}=LX−ISX1−LSX−ISX2 (9)

That is, the one end point of the window WIN2 in the (+X)-direction coincides with the one end point of the field VXA in the (+X)-direction, the scanning operation of the one-dimensional filter FX1 ends.

FIG. 9 shows the change of variance VI(X_{W1}) depending on the X-position X_{W1} among the thus-obtained average value μI(X_{W1}) fluctuation SI(X_{W1}), and variance VI (X_{W1}) (X_{S1}≦X_{W1}≦X_{E}) at each X-position X_{W1} of the one-dimensional filter FX1. That is, upon the start of the scan of the one-dimensional filter FX1, e.g., the area in the window WIN2 is the mark signal area wherein the change of signal intensity I(X) is remarkable and the variance VI(X_{W1}) is large. However, as the scanning operation of the one-dimensional filter FX1 advances, the areas in the window WIN1 and the window WIN2 come to include the forbidden signal area wherein the change of signal intensity I(X) is easy. As the ratio of occupation of the forbidden band signal area in the areas of the window WIN1 and the window WIN2 becomes larger, the variance VI(X_{W1}) is decreased. When the areas of the window WIN1 and the window WIN2 coincide with the forbidden band signal area, the variance VI(X_{W1}) becomes a minimum VI₀. When the scanning operation of the one-dimensional filter FX1 further advances, the variance VI(X_{W1}) is increased as the radio of the forbidden band signal area in the areas of the window WIN1 and the window WIN2 is decreased.

In accordance therewith, the extracting unit 32 detects an X-value for which VI(X_{W1}) becomes the minimum VI₀ (X_{S1}≦X_{W1}≦X_{E}) and which is denoted by X_{W0}, thereby extracting not only the position of the forbidden band signal area in the field area VAX but also the position of the mark signal area. Namely, the following relationship between the X-value X_{W0} and the above unknown-value ESX1 is established.

X_{W0}=X_{S1}+ESX1=X₀+ESX1 (10)

The extracting unit 32 obtains the value ESX1 based on the expression (10). As a consequence, obviously, the mark signal area is an area between an X-position X₁ (=ESX1+ISX1) and an X-position X₂ (=ESX1 30 ISX1+LSX). The thus-extracted mark signal area (X₁≦X≦X₂) is extracted with position precision which is much smaller than that of the line pattern width or space pattern width and is, e.g., that of several tenths of the line pattern width or space pattern width. If the position precision (hereinbelow, referred to as “area precision”) is set to Δ, the following relationship between a proper start X-position X₁₀ of the mark signal area and the X-position X₁ is established.

X₁−Δ≦X₁₀≦X₁+Δ (11)

Incidentally, the area precision Δ is a given value in the case of extracting the mark area using the above method. The extracting unit 32 stores the X-positions X₁ and X₂, the area precision Δ, and the signal intensity I(X) (X₁≦X≦X₂) in the area information storing area 42.

Next, the extracting unit 32 obtains the following expressions.

μI₀=μI(X_{W0}) (12)

σI₀={VI(X_{W0})}^{½} (13)

Ideally, the value μI₀ expressed by the expression (12) is an average of the signal intensity I(X)'s which are measured in the forbidden band signal area where a constant signal intensity is obtained and the value σI₀ expressed by the expression (13) is a standard deviation of the signal intensity I(X)'s which are measured in the forbidden band signal area. In other words, the value μI₀ includes normalized information of the image pick-up result in step 202 and the value σI₀ includes noise-level information of the image pick-up result. The extracting unit 32 stores the value μI₀ and the value σI₀ in the area information storing area 42. Accordingly, the extraction of the mark signal area ends.

Referring back to FIG. 6, in the subroutine 204, the X-position of the mark position MX (i₁, j₁) is obtained by using a simplex method. The simplex method of the present embodiment uses α(k) (k: natural number) defined by the following expressions as a characteristic value.

α(1)=1, α(2)=½, α(3)=−½,

α(k)=α(k−2)/2 (k: integer, k≧4) (14)

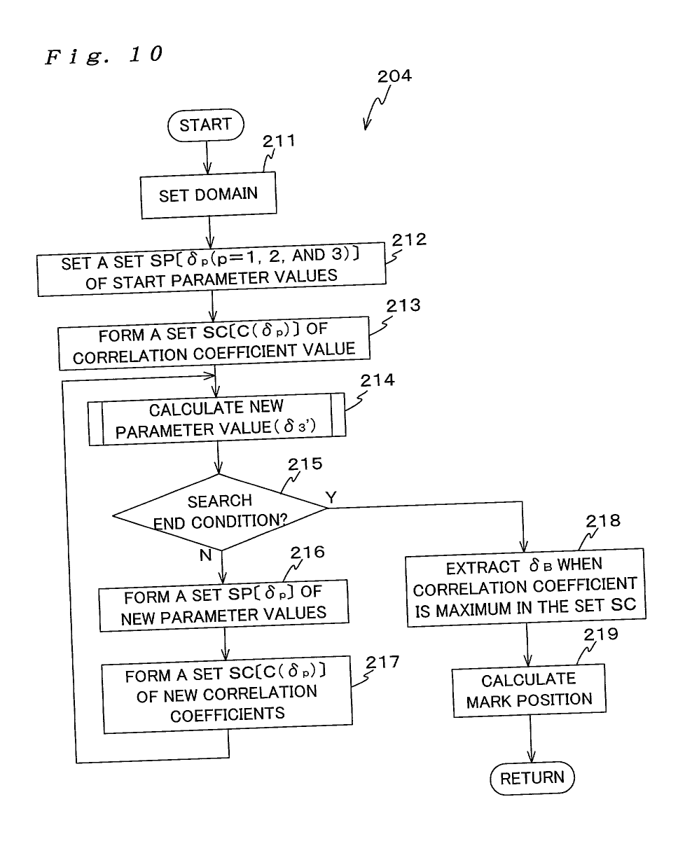

In the subroutine 204, as shown in FIG. 10, in step 211, the search unit 33 first reads out the X-position X₁, X-position X₂, area precision Δ, signal waveform I(X) (X₁−Δ≦X≦X₂+Δ), value μI₀, and value σI₀ from the area information storing area 42 in response to the instruction from the control unit 39, and also reads out a template waveform T(X) from the template storing area 46, thereby preparing the execution of the simplex method in which a correlation coefficient between the signal waveform I(X) and the template waveform T(X) is an evaluation function. That is, the search unit 33 adjusts the origin of the template waveform T(X) so that the start of the X-position of the mark area in the template waveform T(X) becomes the value X₁. The search unit 33 sets a domain of a parameter δ as follows when calculating the correlation coefficient while changing the positional relationship between the signal waveform I(X) and the template waveform T(X).

−Δ≦δ≦+Δ (15)

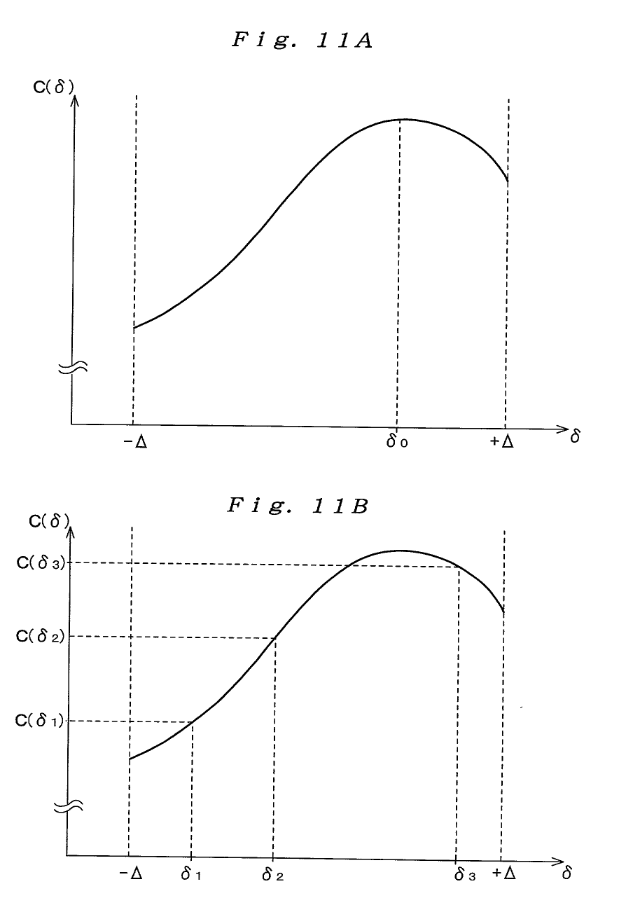

This domain is shown by [−Δ, +Δ]. With respect to the value of the parameter 6 in the domain [−Δ, +Δ], a correlation coefficient C(δ) between the signal waveform I(X) and the template waveform T(X+δ) is calculated. Since, as mentioned above, a width of the domain [−Δ, +Δ] is substantially narrower than the line pattern width or space pattern width in the signal waveform, a distribution of the correlation coefficient C(δ) between the signal waveform I(X) and the template waveform T(X+δ) in the domain [−Δ, +Δ] has a single peak as shown in FIG. 11A.

Referring back to FIG. 10, in step 212, the search unit 33 sets a set SP [δₚ (p=1 to 3)] of the parameter values which includes three different start values δ₁, δ₂, and δ₃ of the parameters 6 as element values for the domain [−ΔA, +Δ]. FIG. 11B shows an example of setting of the start values δₚof the parameters δ. Note that in the case of setting the start values δₚ, preferably, the start value δₚ is set so that there is one start value δₚ near both end points in the domain [−Δ, +Δ], respectively, and there is one start value δₚ near the center.

Referring back to FIG. 10, in step 213, the search unit 33 calculates a correlation coefficient (normalized correlation coefficient) C(δₚ) between the signal waveform I(X) and the template waveform T(X+δₚ). When the correlation coefficient is calculated, the normalized template waveform T(X+δₚ) and the signal intensity I(X) normalized by the value μI₀ are used and the noise level estimated from the value σI₀ is considered. In the aforementioned example in FIG. 11B,

C(δ₁)<C(δ₂)<C(δ₂). (16)

Subsequently, the search unit 33 forms a set SC[C(δₚ)] of the correlation coefficients which includes the correlation coefficient C(δₚ) as an element.

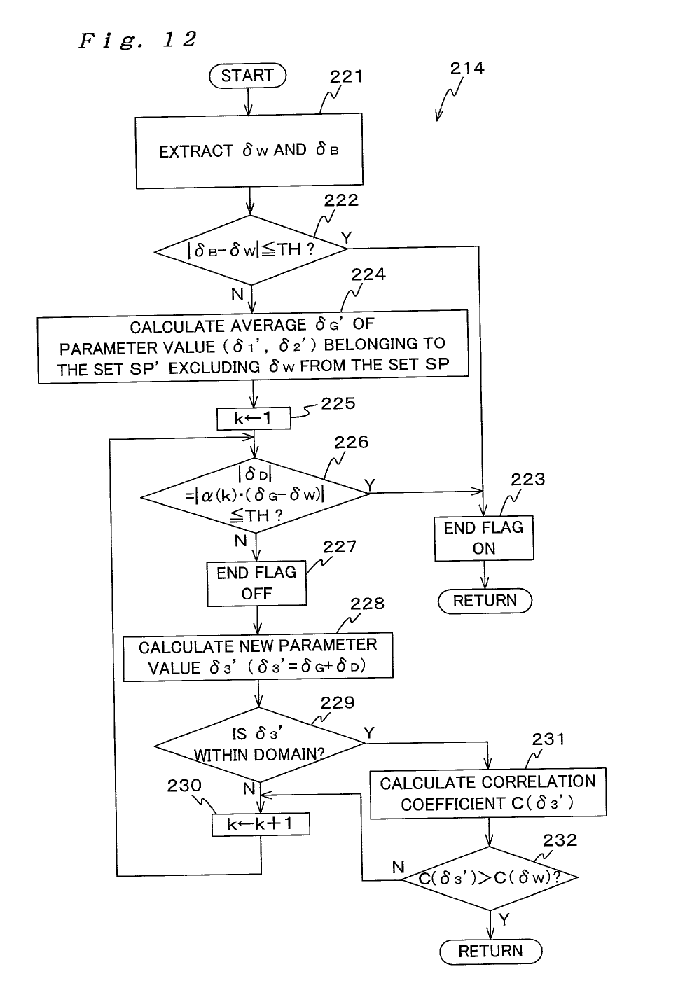

Referring back to FIG. 10, in the subroutine 214, a new parameter value (assumed as δ₃′) is calculated by using the algorithm of the simplex method. As shown in FIG. 12, in the case of calculating the new parameter value δ₃′, in step 221, the search unit 33 first extracts a parameter value δ_{W} having a minimum correlation coefficient in the set SC of the correlation coefficients (parameter value δ₁ in the example of FIG. 11B) and a parameter value δ_{B} having a maximum correlation coefficient in the set SC of the correlation coefficients (parameter value δ₃ in the example of FIG. 11B)

In step 222, the search unit 33 determines whether or not the parameter values δ_{W} and δ_{B} satisfy the following condition (hereinbelow, referred to as “condition 1”) about the predetermined position detecting precision TH (e.g., 1/100-pixel) in the present embodiment.

|δ_{B}−δ_{W}|≦TH (17)

Thereby, it is determined whether or not the search precision is equal to the predetermined position detecting precision TH or less. As mentioned above, if one start value δₚ is set near each end point in the domain [−Δ, +Δ], and one start value δₚ is set near the center, the determination on the condition 1 in step 222 is NO and the processing routine proceeds to step 224. On the contrary, if the determination on the condition 1 in step 222 is YES, the processing routine proceeds to step 223. Assume that the determination on the condition 1 in step 222 is NO in this case, the following description is given.

In step 224, the search unit 33 calculates an average δ_{G} between parameter values δ₁′ and δ₂′ which belong to the set SP′[δ₂′, δ₂′] excluding the parameter value δ_{W} from the set SP[δₚ] of the parameter values based on the following expression.

δ_{G}=(δ₁′+δ₂′)/2 (18)

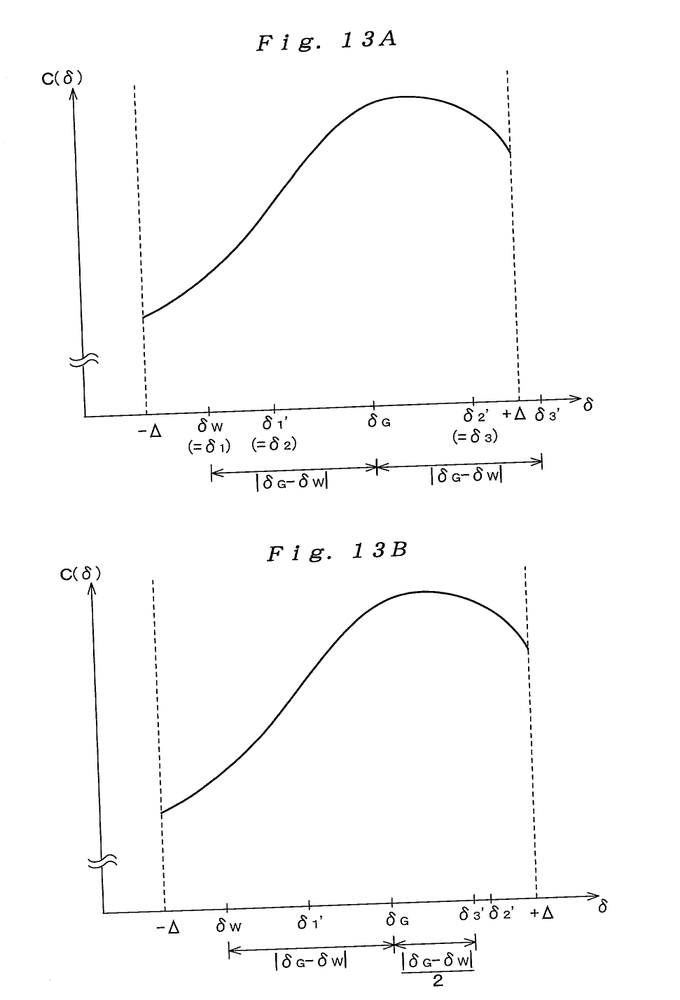

In the example of FIG. 11B, the parameter values δ₂ and δ₃ become parameter values δ₁′ and δ₂′, and the average δ_{G} is located at the position shown in the figure, as shown in FIG. 13A.

Referring back to FIG. 12, subsequently, in step 225, the search unit 33 sets a parameter k to 1. As a result, the characteristic variable α(k) in the above-described simplex method is as follows.

α(k)=α(1)=1 (19)

In step 226, the search unit 33 calculates

δ_{D}=α(k)·(δ_{G}−δ_{W}) (20)

based on the characteristic variable α(k), average δ_{G}, and the minimum correlation position δ_{W}. Then, the search unit 33 determines whether or not the following condition (hereinbelow, referred to as “condition 2”) is satisfied.

|δ₀|≦TH (21)

Thereby, it is determined whether or not the search precision is equal to the position detecting precision TH or less. If the determination on the condition 2 in step 226 is YES, the processing routine shifts to step 223. On the other hand, if the determination on the condition 2 in step 226 is NO, the processing routine shifts to step 227. Assume that the determination on the condition 2 in step 226 is NO in this case, the following description is given.

In step 227, the search unit 33 sets an end flag of search to OFF. Then, the search unit 33 starts to search a new parameter value δ₃′.

Subsequently, in step 228, the search unit 33 calculates the new parameter value (to be more specific, a candidate of the new parameter value) δ₃′ by the following expression.

δ₃′=δ_{G}+δ_{D}=δ_{G}+(δ_{G}−δ_{W}) (22)

The thus-calculated new parameter δ₃′ is shown in FIG. 13A.

Referring back to FIG. 12, in step 229, the search unit 33 determines whether or not the new parameter value δ₃′ is within the domain [−Δ, +Δ]. In the example in FIG. 13A, the new parameter value δ₃′ is outside of the domain [−Δ, +Δ], so that the determination by the search unit 33 is NO and the processing routine shifts to step 230. On the other hand, the determination in step 229 is YES, the processing routine shifts to step 231. Assume that the determination in step 229 is NO in this case, the following description is given.

If the determination in step 229 is NO, the search unit 33 increments the parameter k by 1. As a result of increment, the characteristic variable α(k) in the simplex method is as follows.

α(k)=α(2)=½ (23)

As mentioned above, the parameter value is updated and, then, the processing routine shifts to step 226. Subsequently thereto, until the determination in step 226 is YES or the determination in step 229 is YES, the processes in steps 226 to 230 are iterated in the same manner as the foregoing. Assume that the new parameter value δ₃′ is within the domain [−Δ, +Δ] as shown in FIG. 13B and the determination in step 229 is YES before the determination in step 226 is YES during the iteration of calculation of the new parameter value δ₃′ and update of the characteristic variable α(k) in the simplex method, the following description is given.

If YES in step 229, the search unit 33 calculates the correlative coefficient C(δ₃′) for the new parameter value δ₃′ in step 231.

In step 232, the search unit 33 determines whether or not the correlative coefficient C(δ₃′) is larger than the above minimum correlation coefficient C(δ^{W}), thereby determining whether or not a proper parameter value is obtained. If NO in step 232, the processing routine shifts to step 230. On the contrary, if YES in step 232, the processes in the subroutine 214 end. Now assume that the determination in step 232 is NO, the following description is given.

If NO in step 232, the search unit 33 increments the parameter k by 1 in step 230. As a result of increment, the characteristic variable α(k) in the simplex method is updated.

If the parameter value is updated, the processing routine shifts to step 226. Subsequently thereto, the processes in steps 226 to 230 are iterated in the same manner as the foregoing until YES in step 226 or YES in step 232. Assume that the correlative coefficient C(δ₃′) for the new parameter value δ₃′ is larger than the minimum correlation coefficient C(δ_{W}) as shown in FIG. 13B and the determination in step 232 is YES during the iteration of calculation of the new parameter value δ₃′ and update of the characteristic variable α(k) in the simplex method before the determination in step 226 is YES, the following description is given.

If YES in step 232, the processes in the subroutine 214 end as mentioned above. Hence, the processing routine shifts to step 215 in FIG. 10.

In step 215, the search unit 33 determines whether or not an end flag is ON, thereby determining whether or not the process is under a search end condition. In this case, the end flag is OFF, then, NO in step 215, and the processing routine shifts to step 216.

In step 216, the search unit 33 forms the set SP[δₚ] of the new parameter values including the parameter values δ₁′, δ₂′, and δ₃′ as elements. Subsequently, in step 217, the search unit 33 forms the set SC[C(δₚ)] of the new correlation coefficients including the correlation coefficient C(δₚ′) as an element which has been already obtained.

When the set SP [δₚ] of the new parameter values and the set SC[C(δₚ)] of the new correlation coefficients are formed, the processing routine shifts to subroutine 214. Subsequently thereto, the processes in subroutine 214 to step 217 are iterated in the same manner as the foregoing whereon the formation of the set SP[δₚ] of the new parameter values and the set SC[C(δₚ)] of the new correlation coefficients is iterated.

During the processes in subroutine 214 to step 217, if the determination on the above condition 1 is YES in step 222 in FIG. 12 or the determination on the above condition 2 is YES in step 226 in FIG. 12, the processing routine shifts to step 223 whereon the search unit 33 sets the end flag to ON. Hence, the processes in subroutine 214 end and the processing routine shifts to step 215 in FIG. 10.

In step 215, the search unit 33 determines whether or not the process is under the search end condition. In this case, the end flag is ON, then, YES in step 215, and the processing routine shifts to step 218.

In step 218, the search unit 33 extracts the maximum correlation coefficient C(δ_{B}) in the set SC[C(δₚ)] of the correlation coefficients in this case and further extracts the parameter value δ_{B} corresponding to the maximum correlation coefficient C(δ_{B}). Then, the search unit 33 stores the parameter value δ_{B} as the maximum correlation position in the maximum-correlation-position-storing area 43.

In step 219, the mark position calculating unit 34 reads out the maximum correlation position at the mark MX(i₁, j₁) from the maximum-correlation-position-storing area 43, also fetches position information WPV of the wafer W from wafer interferometer 18, and further obtains the X-position of the mark MX(i₁, j₁) based on the maximum correlation position and position information WPV. The mark position calculating unit 34 stores the thus-obtained X-position of the mark MX(i₁, jᵢ) in the mark position storing area 44. Hence, the processes in the subroutine 204 end and the processing routine shifts to step 205 in the main routine in FIG. 6.

Next, in step 205, it is determined whether or not calculation of the mark information on all selected marks is completed. The above case indicates the completion of the mark information of only one mark MX (i₁, j₁) , i.e., the completion of the X-position of the mark MX(i₁, j₁). Therefore, the determination in step 205 is NO and the processing routine proceeds to step 206.

In step 206, the control unit 39 moves the wafer W at the position at which the next mark is included in the image pick-up field of the alignment system AS. The control unit 39 controls the wafer driving unit 24 via the stage control system 19 and moves the wafer stage WST on the basis of the pre-alignment result, thereby moving the wafer W.

Subsequently, the X-position of the mark MX(iₘ, jₘ) (where m=2 to M) and the Y-position of the mark MY(iₙ, jₙ) (where n=1 to N) are calculated similarly to the case of the above mark MX(i_{1, j}ᵢ) until it is determined that the mark information on all selected marks is calculated in step 205. As mentioned above, if the position information of all selected marks is calculated and is stored in the mark position storing area 44 and the determination in step 205 is YES, the processing routine proceeds to step 207.

In step 207, the error parameter calculating unit 35 reads out the X-position of the mark MX (iₘ, jₘ) (where m=2 to M) and the Y-position of the mark MY (iₙ, jₙ) (where n=1 to N) from the mark position storing area 44, also calculates an error parameter value for calculation of the arrangement coordinate of the shot area SA on the wafer W from a statistical operation disclosed in, e.g., Japanese Unexamined Patent Application Publication No. 61-44429 and its corresponding U.S. Pat. No. 4,780,617 and Japanese Unexamined Patent Application Publication No. 2-54103 and its corresponding U.S. Pat. No. 4,962,318. The disclosure described in the above is fully incorporated as reference herein. The error parameter calculating unit 35 further stores the obtained error parameter value in the parameter value storing area 45.

Subsequently, the control unit 39 reads out the error parameter value from the error parameter value storing area 45, systematically controls the exposure apparatus 100 by using the shot area arrangement which is obtained by using the error parameter value, and synchronously moves the wafer W and the reticle R in the opposite direction to each other along the scanning direction (Y-direction) at a speed ratio corresponding to projection magnification in such a state that a slit-shaped illuminated area (of which the center is almost matched to the optical axis AX) on the reticle R is irradiated with the illumination light IL. Thereby, the pattern of the pattern area on the retile R is shrunk and transferred onto the shot area on the wafer W.

As described above, according to the present embodiment, with respect to the image pick-up result of the marks MX and MY formed by the alignment system AS, the extracting unit 32 extracts the domain of the parameter δ in which the distribution of the correlation coefficients between the signal waveform I(X) and the template waveform T(X+δ) has a single peak, the search unit 33 obtains the value of parameter δ at which the correlation coefficient between the signal waveform I(X) and the template waveform T(X+δ) becomes maximum in the extracted domain by the simplex method whereby the correlation coefficient is an evaluation function, and the position calculating unit 34 obtains the positions of the marks MX and MY based on the obtained positional relationship. Therefore, it is capable of detecting the positions MX and MY fast and precisely. In the present embodiment, it is capable of calculating the arrangement coordinate of the shot area SA(i, j) on the wafer W with high precision on the basis of the positions of the mark MX and MY which are obtained accurately and capable of implementing the alignment of the wafer W with high precision on the basis of this calculation result and, accordingly, it is capable of transferring the pattern formed on the retile R onto the shot area SA(i, j).

In the present embodiment, the exposure apparatus 100 is manufactured through comprehensive adjustment electrical adjustment and the confirmation of the operation etc. ) after elements shown in FIG. 1 etc. are assembled to be electrically, mechanically and optically aligned. Incidentally, the manufacturing of the exposure apparatus 100 had better be done in a clean room of which the temperature, the degree of cleanness and the like are controlled.

Incidentally, in the present embodiment, the condition 1 or condition 2 is the end condition of the process based on the simplex method, the condition 1 and condition 2 can become the end condition. The condition 1 is that the difference between the minimum correlation position and the average position of the positions excluding the minimum correlation position in the set SP is equal to a desired position precision or less, and the condition 2 is that the difference between the minimum correlation position and the maximum correlation position in the set SP is equal to a desired position precision or less. Also, it is possible to set a state that the absolute value of the characteristic variable α(k) is equal to a predetermined lower limit value or less as the end condition of the processes based on the simplex method. Further, it is possible to set a state that the number of calculating times of the correlation coefficient C(δ₃′) for the new parameter value δ₃′ is in excess of a predetermined upper limit value, as the end condition of the simplex method.

Although, in the present embodiment, α(k) which is defined by the above expression (14) is adopted as the characteristic value of the simplex method, it is possible to adopt any variable so long as the variable satisfies the following expressions (24) and (25).

α(k₁)≧α(k₂) (k₁<k₂) (24)

Although, in the present embodiment, the number of start values of the parameter δ, the number of elements of the set SP of the parameter values, and the number of elements of the set SC of the correlation coefficients are three, respectively, in the application of the simplex method, it is possible to set any desired number thereto if the number is an integer and is equal to three or more.

Although, in the present embodiment, the simplex method is adopted as the search algorithm of the maximum correlation position, it is possible to adopt a binary search method or dichotomizing search method, alternatively, a gradient method.

Although, in the present embodiment, the two windows WIN1 and WIN2 are provided corresponding to the forbidden band signal areas on both sides of the mark signal area, it is possible to provide a single window. In this case, if the single window is scanned in the field area VXA and the variance of signal intensities in the window is obtained in the same manner as that of the present embodiment, two window position (positions of the one-dimensional filter) at which the variance is locally minimized are observed corresponding to the forbidden band signal area on both sides of the mark signal area. Thus, based on the two observed window positions, it is possible to extract not only the mark signal area but also the domain of the calculation of the correlation coefficient.

Moreover, when the signal intensity value in the forbidden band signal area becomes maximum and almost constant as in the present embodiment, it is possible to extract not only the mark signal area but also the domain of the calculation of the correlation coefficient if obtaining the position of the one-dimension filter at which an average μI(X_{W1}) calculated by the expressions (3) and (6) becomes maximum.

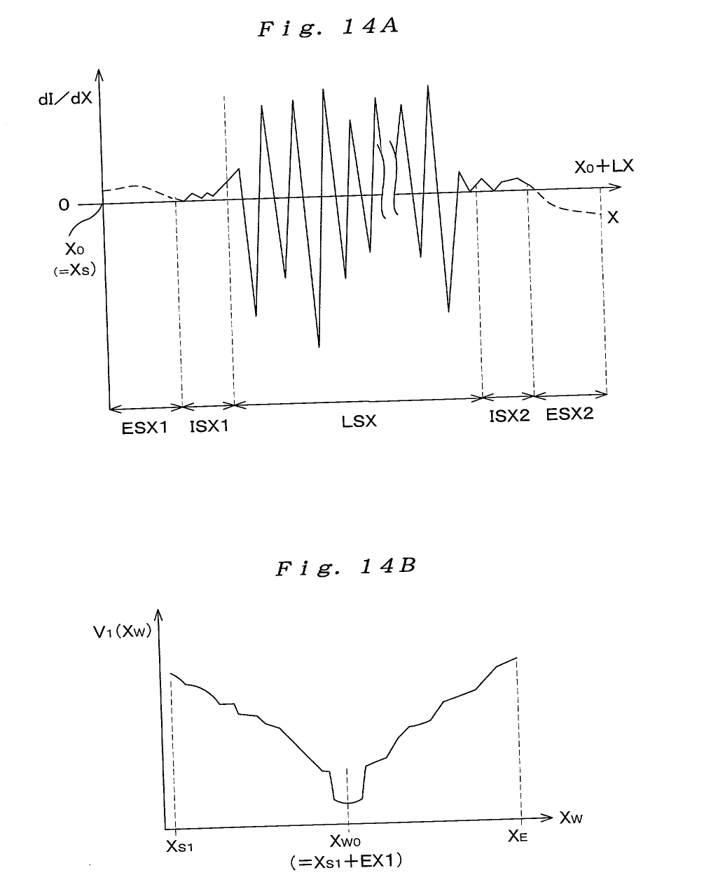

Although the present embodiment uses the light intensity signal I(X) to be obtained directly from the image pick-up result so as to extract the mark signal area, it is also possible to use the first-order position differentiating signal dI(X)/dX of the light intensity signal I(X) shown in FIG. 14A. In this case, the signal level is approximately at the zero-level in the forbidden band signal area and it markedly changes in the mark signal area. In other words, similarly to the present embodiment, the signal level easily changes in the forbidden band area and it markedly changes in the mark signal area. Accordingly, if providing the same one-dimensional filter FX1 as that of the present embodiment, scanning the internal field area VXA, and simultaneously calculating the variance V₁(X_{W1}) of the first-order position differentiating signal dI(X)/dX in the windows WIN1 and WIN2 in the same manner as that of the present embodiment, the variance V₁(X_{W1}) shown in FIG. 14B is obtained. Hence, by obtaining an X-position X_{W0} of the one-dimensional filter FX1 at which the variance V₁(X_{W1}) in FIG. 14B is minimum, it is also possible to acquire the extraction result of not only the mark signal area but also the domain of the calculation of the correlation coefficient, similarly to the present embodiment.

Further, if using the hth-order position differentiating signal (h≧2) of the light intensity signal I(X), the signal level easily changes in the forbidden band signal area and it markedly changes in the mark signal area. Accordingly, if also using the hth-order position differentiating signal of the light intensity signal I(X), it is possible to extract not only the mark signal area but also the domain of the calculation of the correlation coefficient, similarly to the present embodiment.

It is noted that in the case of using the sth-order differentiating signal (s≧1) of the light intensity signal I(X), the average and the standard deviation of the signal intensity in the window at the position at which the variance is minimized are obtained corresponding to the above expressions (12) and (13), and are values reflecting the level of the noise being superimposed on the sth-order differentiating signal, respectively.

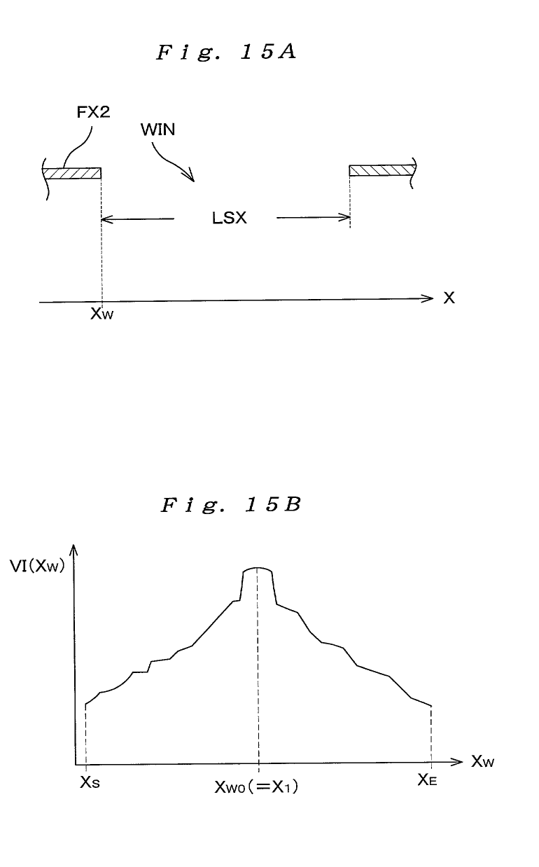

Although the present embodiment takes account of the forbidden band signal area, in which the signal intensity easily changes, and uses the one-dimensional filter FX1 having the window corresponding to the forbidden band signal area, it is possible to extract not only the mark signal area but also the domain of the calculation of the correlation coefficient by taking account of the mark signal area in which the marked change of signal level continues throughout the width LSX. In this case, a one-dimensional filter FX2 having a window WIN of the width LSX is provided as shown in FIG. 15A. The one-dimensional filter FX2 scans the inside of the field area VXA and simultaneously calculates the variance VI(X_{W}) of the signal intensity I(X) in the window WIN, in the similar manner to that of the present embodiment. The thus-obtained variance VI(X_{W}) becomes maximum when the area in the window WIN matches to the mark signal area, as shown in FIG. 15B. Therefore, by obtaining the position X_{W0} (=X₁) of the one-dimensional filter FX2 at which the variance VI(X_{W}) becomes maximum in FIG. 15B, it is possible to extract not only the mark signal area but also the domain of the calculation of the correlation coefficient.

Incidentally this case uses the following expressions (26) and (31), in place of the expressions (3) to (8) in the above embodiment, when calculating the average μI(X_{W}), fluctuation SI(X_{W}), and the variance VI(X_{W}) of the signal intensity in the window WIN.

$$\begin{matrix}μ I ( {X}_{W} ) = \{ {\sum }_{i = 1}^{LSX} I ( {X}_{W} + i ) \} / LSX & ( 26 ) \\ SI ( {X}_{W} ) = {\sum }_{i = 1}^{LSX} {\{ I ( {X}_{W} + i ) \}}^{2} & ( 27 ) \\ VI ( {X}_{W} ) = SI ( {X}_{W} ) / LSX - {\{ μ I ( {X}_{W} ) \}}^{2} & ( 28 ) \\ μ I ( {X}_{W} + 1 ) = μ I ( {X}_{W} ) + \{ I ( {X}_{W} + LSX1 + 1 ) - I ( {X}_{W} ) \} / LSX & ( 29 ) \\ SI ( {X}_{W} + 1 ) = SI ( {X}_{W} ) + [ {\{ I ( {X}_{W} + LSX1 + 1 ) \}}^{2} - {\{ I ( {X}_{W} ) \}}^{2} ] & ( 30 ) \\ VI ( {X}_{W} + 1 ) = SI ( {X}_{W} + 1 ) / LSX [ {\{ μ I ( {X}_{W} + 1 ) \}}^{2} & ( 31 )\end{matrix}$$

In order to obtain normalized information and noise level information capable of being used upon calculating the later mark-position, it is necessary to specify the forbidden band signal area on both sides of the mark signal area after extracting the mark signal area and to calculate the average and variance of the signal intensity in the forbidden band signal area.

Note that it is possible to use the sth-order differentiating signal (s≧1) of the light intensity signal I(X) when using the above one-dimensional filter FX2.

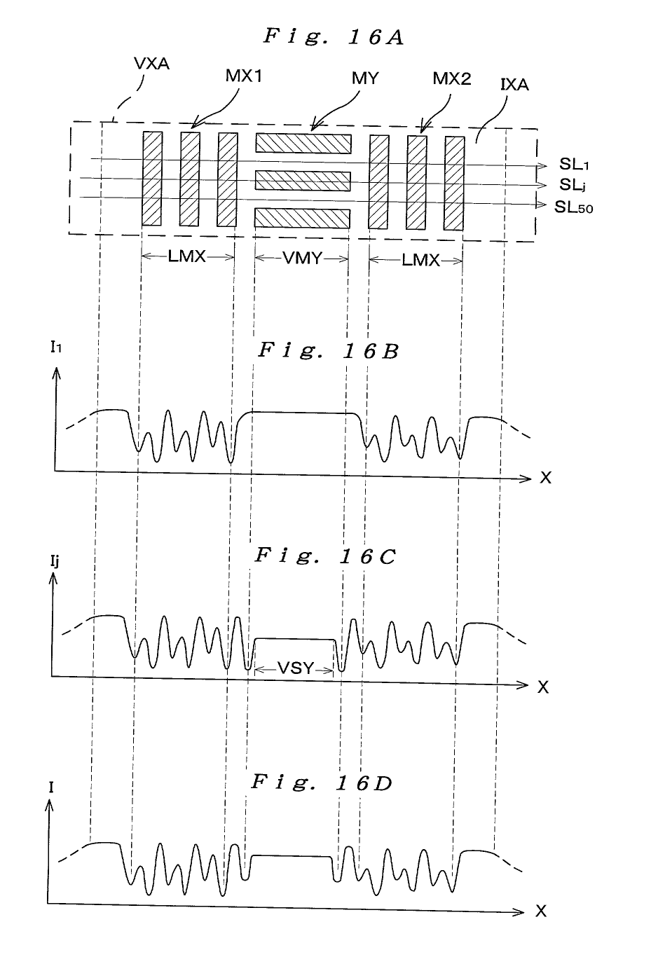

Although the present embodiment uses the one-dimensional mark of the line and space pattern shown in FIG. 2B as a mark, it is possible to use a mark for detecting a two-dimensional position serving as a complex mark in which the mark MX1 for detecting the X-position, the mark MY for detecting the Y-position, and the mark MX2 for detecting the X-position are sequentially arranged, which is shown in FIG. 16A as an example. The mark for detecting the two-dimensional position is preferably used for calculation of the arrangement coordinate of the shot area SA on the wafer W and the coordinate in the shot area SA on the basis of the statistical operation which is disclosed in, e.g., Japanese Patent Unexamined Application Publication No. 6-275496 and its corresponding U.S. Pat. No. 0,000,000. The disclosure described in the above is fully incorporated as reference herein.

With respect to the two-dimensional mark shown in FIG. 16A as well, it is possible to extract the mark signal area by paying attention to the forbidden band signal area or mark signal area in the similar manner to that of the present embodiment, on detecting the X-position and Y-position. However, it is possible to extract not only the mark signal area but also the domain of the calculation of the correlation coefficient by paying attention to the mark signal area having a width VSY corresponding to the mark MY on extracting the mark signal area in the X-direction. That is, consider each of scanning lines SL₁ to SL₅₀, in the mark signal area corresponding to the mark MY, the signal intensity in the space portion continues to be an approximately constant value as representatively shown by the scanning line SL₁ in FIG. 16B, alternatively, the signal intensity in the line portion continues to be an approximately constant value as representatively shown by the scanning line SLⱼ in FIG. 16C. Consequently, if obtaining the average of the signal intensity at the X-position in the individual scanning lines SL₁ to SL₅₀, an approximately constant value between the signal intensity in the space portion and the signal intensity in the line portion continues in the mark signal area having the width VSY corresponding to the mark MY as shown in FIG. 16D. That is, normally, there is no area having the signal intensity of an approximately constant value throughout a large width in the field area VXA.

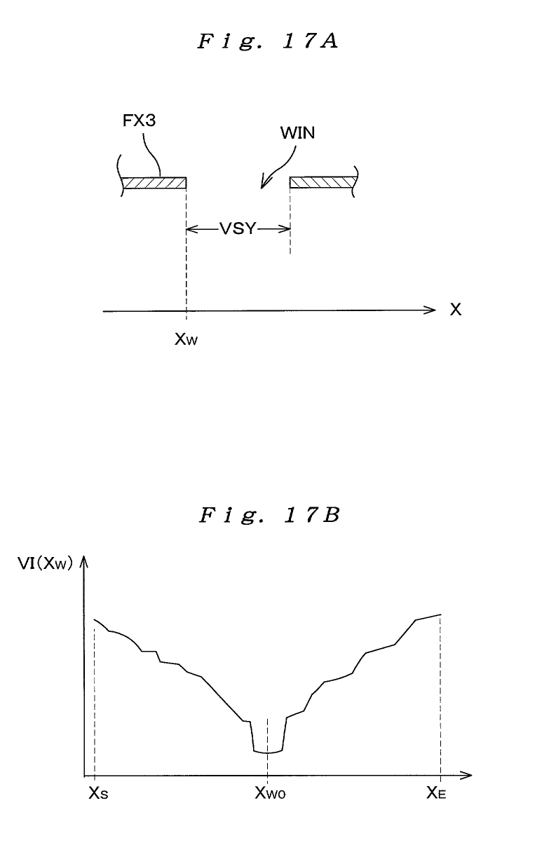

Then, a one-dimensional filter FX3 having a window WIN of a width VSY is provided as shown in FIG. 17A, and the inside of the field area VXA is scanned and the variance VI(X_{W}) is simultaneously calculated in the same manner as that of the present embodiment. As shown in FIG. 17B, the thus-obtained variance VI(X_{W}) becomes minimum when the window WIN inner area matches to the mark signal area corresponding to the mark MY. Accordingly, in FIG. 17B, by obtaining a position X_{W0} of the one-dimensional filter FX3 at which the variance VI(X_{W}) becomes minimum, it is possible to extract not only the mark signal area but also the domain of the calculation of the correlation coefficient.

Note that in the case of using the above one-dimensional filter FX3 as well, it is possible to use the sth-order differentiating signal (s≧1) of the light intensity signal I(X).

Obviously, the present invention can be applied to a mark having another shape.

Although the mark-formed on the street line is used in the present embodiment, the present invention is not limited thereto. Further, also when the street line itself is handled as a mark, the arrangement coordinate of the shot area can be calculated.

Although the scanning operation for the window is executed by movement of each one pixel in a predetermined direction in the present embodiment, the scanning operation may be executed by movement of plural pixels in a predetermined direction.

The extraction of the domain of the calculation of the correlative coefficient is not limited to the method using the above one-dimensional filter. So long as the single peak of the correlative coefficient is realized, other methods can be used.

Although the alignment system is an off-axis system for directly measuring the position of the alignment mark on the wafer not through the projection optical system in the present embodiment, it is possible to adopt a TTL (Through The Lens) system for measuring the position of the alignment mark on the wafer through the projection optical system and a TTR (Through The Reticle) system for simultaneously observing the wafer and the reticle through the projection optical system. Incidentally, in the case of the TTR system, on observation, the position of the wafer mark where the deviation between the reticle mark-formed on the reticle and the wafer mark-formed on the wafer is equal to zero is detected in sample alignment.

Although the coordinate of the each shot area is calculated in the present embodiment, a step pitch of each shot may be calculated.

The above-mentioned embodiment is explained by using the scanning type exposure apparatus. However, the present invention may apply to any type of the wafer exposure apparatus or liquid crystal exposure apparatus or the like, for example, the reduced projection exposure apparatus of which light source is ultraviolet and soft X-ray with its wave length about 10 nm, X-ray exposure apparatus of which light source is X-ray with its wave length 1 nm, EB (electron beam) or ion beam exposure apparatus. Furthermore, the present invention may apply to a step-and-repeat machine, a step-and-scan machine, and a step-and-switching machine.

In the above-mentioned embodiment, the position detection of the position mark-formed on the wafer and the positioning of the wafer in exposure apparatus are explained. However, the position detection and positioning in which the present invention is applied might be employed for the position detection of the positioning mark-formed on the reticle, or positioning of the reticle. Furthermore, the position detection and positioning are applicable to the apparatus except exposure apparatuses, for example, an observation apparatus for an object by using a microscope or the like, a positioning apparatus for a subject in the assembly line, the modification line, or inspection line in the factory.

<Device manufacturing>

A device manufacturing method using the exposure apparatus and exposure method above will be described.

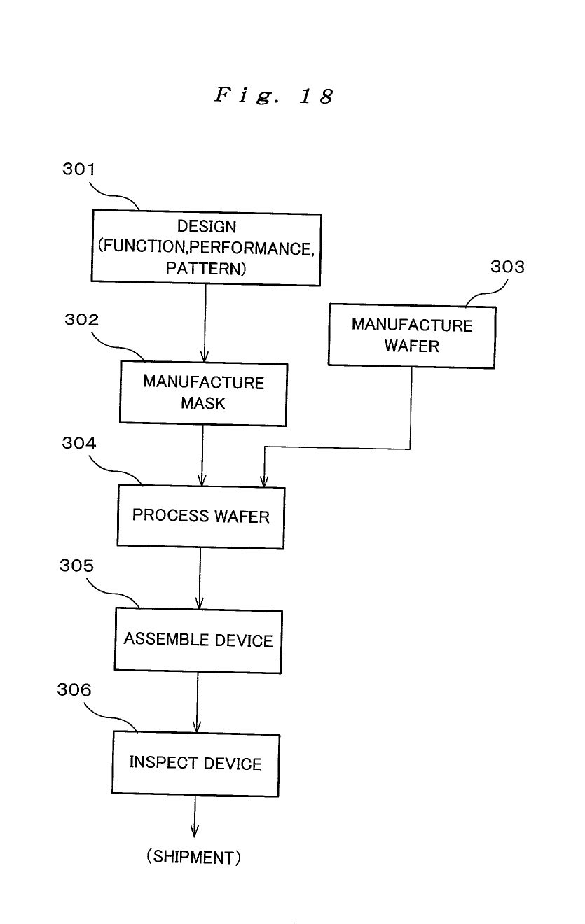

FIG. 18 is a flowchart showing an example of manufacturing a device (a semiconductor chip such as an IC, or LSI, a liquid crystal panel, a CCD, a thin film magnetic head, or a micromachine). As shown in FIG. 18, in step 301 (design step), function/performance is designed for a device (e.g., circuit design for a semiconductor device) and a pattern to implement the function is designed. In step 302 (mask manufacturing step), a mask on which the designed circuit pattern is formed is manufactured. In step 303 (wafer manufacturing step), a wafer is manufactured by using a material such as silicon.

In step 304 (wafer processing step), an actual circuit, etc. are formed on the wafer by lithography using the mask and wafer prepared in steps 301 to 303, as will be described later. In step 305 (device assembly step), a device is assembled by using the wafer processed in step 304, thereby forming the device into a chip. Step 305 includes processes (dicing and bonding) and packaging (chip encapsulation).

Finally, in step 306 (inspection step), a test on the operation of the device manufactured in step 305 and durability test, etc. are performed. After these steps, the device is completed and shipped out.

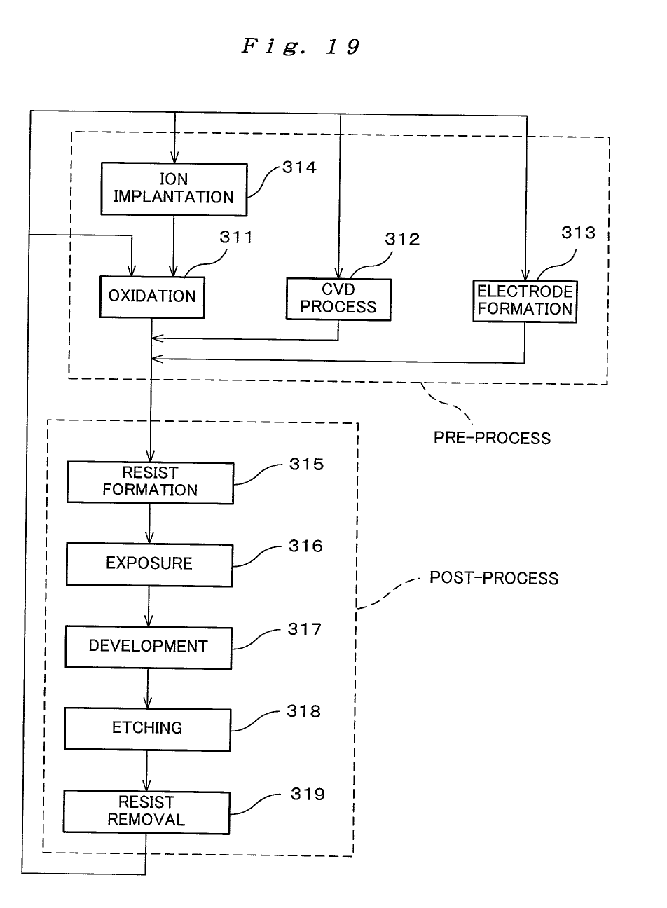

FIG. 19 is a flowchart showing the detailed example of step 304 described above in manufacturing the semiconductor device. Referring to FIG. 19, in step 311 (oxidation step), the surface of the wafer is oxidized. In step 312 (CVD step), an insulation film is formed on the wafer surface. In step 313 (electrode formation step), an electrode is formed on the wafer by vapor deposition. In step 314 (ion implantation step), ions are implanted into the wafer. Steps 311 to 314 described above constitute a pre-process for the respective steps in the wafer process and are selectively executed in accordance with the processing required in the respective steps.

When the above pre-process is completed in the respective steps in the wafer process, a post-process is executed as follows. In this post-process, first, in step 315 (resist formation step), the wafer is coated with a photosensitive agent. Next, in step 316 (exposure step), the circuit pattern on the mask is transcribed onto the wafer by the above exposure apparatus and method. Then, in step 317 (developing step), the exposed wafer is developed. In step 318 (etching step), an exposed member on a portion other than a portion where the resist is left is removed by etching. Finally, in step 319 (resist removing step), the unnecessary resist after the etching is removed.

By repeatedly performing these pre-process and post-process, multiple circuit patterns are formed on the wafer.

As described above, the device on which the fine patterns are precisely formed is manufactured.

While the above-described embodiments of the present invention are the presently preferred embodiments thereof, those skilled in the art of lithography system will readily recognize that numerous additions, modifications and substitutions may be made to the above-described embodiments without departing from the spirit and scope thereof. It is intended that all such modifications, additions and substitutions fall within the scope of the present invention, which is best defined by the claims appended below.

What is claimed is:

1. A position detecting method for detecting position information of a mark-formed on an object, comprising:
observing said mark;
extracting a domain, which reflects said mark and in which a distribution of correlation coefficients obtained by a template matching method for said observation result using a predetermined template has a single peak, from an observation result of said mark;
obtaining a positional relationship, in which said correlation coefficient is maximum in said domain, between said observation result and said predetermined template by using a hill climbing method; and
detecting position information of said mark based on said obtained positional relationship.

2. The position detecting method according to claim 1, wherein
said mark is associated with an mark-outside area whose surface state has characteristics different from those of another area and which is outside of a mark-formed area where said mark is formed in a predetermined direction; and
said extracting the domain comprises:
obtaining a characteristic amount corresponding to said characteristics at each position of a window which has a size corresponding to said mark-outside area, based on an observation result in said window, while scanning said window; and
extracting said domain based on changes of said characteristic amount corresponding to positional change of said window.

3. The position detecting method according to claim 2, wherein
said characteristic amount is at least one of an average and a variance of said observation result in said window.

4. The position detecting method according to claim 1, wherein
said mark has an mark-inside area whose surface state has characteristics different from those of another area in said mark-formed area in a predetermined direction, and
said extracting the domain comprises:
obtaining a characteristic amount corresponding to said characteristics at each position of a window which has a size corresponding to said mark-inside area, based on an observation result in said window, while scanning said window; and
extracting said domain based on changes of said characteristic amount corresponding to positional change of said window.

5. The position detecting method according to claim 4, wherein
said characteristic amount is at least one of an average and a variance of said observation result in said window.

6. The position detecting method according to claim 1, wherein
said hill climbing method is a simplex method in which an evaluation function is said correlation coefficient.

7. A position detecting apparatus for detecting position information of a mark-formed on an object, comprising:
an observing unit which observes said mark;
an extracting unit which is electrically connected to the observing unit and extracts a domain, which includes an observation result by said observing unit that reflects said mark and in which a distribution of correlation coefficients obtained by a template matching method for said observation result using a predetermined template has a single peak, from said observation result;
a search unit which is electrically connected to the extracting unit and obtains a positional relationship, in which said correlation coefficient is maximum in said domain, between said predetermined template and said observation result by using a hill climbing method; and
a position calculating unit which is electrically connected to the search unit and detects position information of said mark based on said positional relationship obtained by said search unit.

8. The position detecting apparatus according to claim 7, wherein
said observing unit comprises an image pick-up unit which picks up an image of said mark-formed on said object, and
said observation result is a light intensity of said mark image which is picked up by said image pick-up unit.

9. The position detecting apparatus according to claim 7, wherein
said extracting unit scans a window having a size corresponding to a specific area whose surface state on said object has characteristics different from those of another area, obtains a characteristic amount corresponding to said characteristics at each position of said window, from an observation result in said window, and extracts an area having said observation result that reflects said mark, based on changes of said characteristic amount corresponding to positional change of said window.

10. The position detecting apparatus according to claim 9, wherein
said surface state includes a state of light from said surface of said object.

11. An exposure method for transferring a predetermined pattern onto a plurality of divided areas on a substrate, comprising:
detecting position information of a position detection mark which is formed on said substrate by using the position detecting method according to claim 1, obtaining a parameter of a predetermined number, with respect to a position of said divided area, and calculating arrangement information of said divided areas on said substrate; and
transferring said pattern onto said divided area by controlling said position on said substrate based on said arrangement information of said obtained divided areas.

12. An exposure apparatus for transferring a predetermined pattern onto a divided area on a substrate, comprising:
a stage unit which moves said substrate along a moving surface; and
the position detecting apparatus according to claim 7 which detects a position of a mark on said substrate that is mounted onto said stage unit.

13. A manufacturing method of an exposure apparatus for transferring a predetermined pattern onto a divided area on a substrate, comprising:
providing a stage unit which moves said substrate along a moving surface; and
providing a position detecting apparatus which detects a position of a mark on said substrate that is mounted onto said stage unit, wherein said position detecting apparatus comprises:
an observing unit which observes said mark;
an extracting unit which is electrically connected to the observing unit and extracts a domain, which includes an observation result by said observing unit that reflects said mark from said observation result and in which a distribution of correlation coefficients obtained by a template matching method for said observation result using a predetermined template has a single peak;
a search unit which is electrically connected to the extracting unit and obtains a positional relationship, in which said correlation coefficient is maximum in said domain, between said observation result and said predetermined template by using a hill climbing method; and
a position calculating unit which is electrically connected to the search unit and calculates said position of said mark based on said positional relationship obtained by said search unit.

14. A computer-readable recording medium for storing a position detecting control program which is executed by a position detecting apparatus for detecting position information of a mark-formed on an object, wherein
said position detecting control program comprises:
allowing said mark to be observed;
allowing a domain, which reflects said mark and in which a distribution of correlation coefficients obtained by a template matching method for an observation result of said mark using a predetermined template has a single peak, to be extracted from said observation result;
allowing a positional relationship, in which said correlation coefficient is maximum in said domain, between said predetermined template and said observation result, to be obtained by using a hill climbing method; and
allowing said position information of said mark to be detected based on said obtained positional relationship.

15. A device manufacturing method including a lithography process, wherein
exposure is performed by using the exposure method according to claim 11 in said lithography process.
